(19) United States
(12) Patent Application Publication
(10) Pub. No.: US 2011/0099032 A1
(43) Pub. Date: Apr. 28, 2011

(54) INFORMATION PROCESSING APPARATUS, INFORMATION PROCESSING METHOD, AND PROGRAM

(75) Inventors: Kazuhiro Miyasa, Yokohama-shi (JP); Akihiro Katayama, Yokohama-shi (JP)

(73) Assignee: CANON KABUSHIKI KAISHA, Tokyo (JP)

(21) Appl. No.: 12/908,215

(22) Filed: Oct. 20, 2010

(30) Foreign Application Priority Data
Oct. 27, 2009 (JP) 2009-246929

(51) Int. Cl. G06Q 50/00

(52) U.S. Cl. 705/3; 705/2

(57) ABSTRACT

An information processing apparatus includes a similar case search unit configured to search for similar case data, which is medical case data including examination information similar to examination information of a medical practice target in characteristics, from a medical case database that stores medical case data including examination information of a subject associated with medical practice difficulty level information based on the examination information. The information processing apparatus further includes a display mode determination unit configured to determine a display mode applicable to the similar case data based on a medical practice difficulty level of the similar case data searched by the similar case search unit, and a display unit configured to display the similar case data according to the display mode determined by the display mode determination unit.

### BACKGROUND OF THE INVENTION

1. Field of the Invention

The present invention relates to an information processing apparatus that can process medical case data including examination information of each subject.

2. Description of the Related Art

There is a conventional medical image processing apparatus that can reduce the burden of a physician who reads a shadow region on a medical image (e.g., an X-ray image, a Computed Tomography (CT) image, and a Magnetic Resonance Imaging (MRI) image). The medical image processing apparatus can automatically detect a diseased region by analyzing a digitized medical image and perform computer aided diagnosis. Hereinafter, the computer aided diagnosis is referred to as CAD.

According to the CAD, an abnormal shadow candidate is automatically detected as a diseased region. More specifically, the abnormal shadow detection processing includes detecting a shadow of abnormal tumor or a shadow of high-density micro calcified region caused by a cancer or the like based on computer-based processing of image data of a radiation image, such as an X-ray image.

The abnormal shadow detection processing further includes presenting a detection result to reduce the burden of a physician who reads a shadow image and improve the accuracy of a read shadow result.

Further, as another conventional CAD technique, there is a conventional technique capable of automatically diagnosing malignancy or disease type about detected abnormal shadow candidates. An example method for realizing the above-described CAD technique is the mammography that estimates a malignancy level of a breast cancer using a Bayesian network.

The Bayesian network is a probabilistic graphical model representing a qualitative relationship between uncertain phenomena, in which a conditional probability table is used to express a quantitative relationship between individual phenomena. If an observable phenomenon such as clinical data (e.g., medical image analysis data, patient attributes, and examination result) is input into the probability model, a probability distribution of an unobserved phenomenon can be calculated beforehand in the diagnosis of a malignancy level of the breast cancer.

When a physician reads a shadow region from a medical image in medical practice (e.g., diagnosis and treatment), the physician may hesitate to make a decision with respect to determination of disease name or treatment if an affected part captured in the medical image has unusual image features or if there are a plurality of diseases having similar image features.

In such a case, the physician may consult with a well-experienced physician or may check medical references (medical documents) to read an explanation about image features of a suspicious disease. Alternatively, the physician may check pictorial medical references including typical photographs to find a disease picture similar to the affected part captured in the medical image and make a decision with respect to the medical practice referring to a disease name attached to the photograph.

However, a reliable physician may not be constantly present. Further, a disease picture similar to the affected part captured in the medical image may not be found. The explanation about image features may not be found. In such cases, a physician reading a shadow region from a medical image may be kept in an unresolved state in the medical practice (e.g., diagnosis or treatment).

A similar case search apparatus, which is operable to search for similar cases with an electronic device, is conventionally known and capable of solving the above-described problem. The similar case search apparatus is basically operable to collect a plurality of pieces of medical case data from a previously stored medical case database according to a predetermined standard and then present (display) information relating to the collected medical cases to a physician for the purpose of assisting physician's medical practice.

As a general search method, there is a conventional method capable of searching for image data of a similar medical image that has image feature information resembling a target medical image from a previously stored image database.

Further, from the viewpoint of assisting the medical practice, presenting similar cases together with a target medical image on the same screen is effective to enable physicians to view and compare all reference information in each medical practice.

However, the amount of medical information displayable on the same screen is limited. Therefore, efficient presentation of medical information is desired.

In this respect, a conventional method discussed in Japanese Patent Application Laid-Open No. 2008-102665 increases the number of similar cases to be presented if a diagnostic target is a patient for the first medical examination and decreases the number of similar cases to be presented if the diagnostic target is patient other than the one for the first medical examination so that previous images of these patients can be presented.

However, the technique discussed in Japanese Patent Application Laid-Open No. 2008-102665 simply refers to a determination result with respect to the first medical examination to change the number of similar cases to be displayed and does not change a display mode considering the necessity of presenting similar cases.

For example, according to the technique discussed in Japanese Patent Application Laid-Open No. 2008-102665, if it is determined that the diagnostic target is a patient for the first medical examination, many similar cases are presented even when the concerned medical case is easy to practice and it is unnecessary to present many similar cases.

On the other hand, according to the technique discussed in Japanese Patent Application Laid-Open No. 2008-102665, if it is determined that the diagnostic target is other patient, the number of similar cases to be presented will be insufficient when the concerned medical case is difficult to practice and it is necessary to present many similar cases.

### SUMMARY OF THE INVENTION

Exemplary embodiments of the present invention are directed to a technique capable of changing a display mode of each similar case so as to reflect the necessity of presenting the similar case in medical practice.

An information processing apparatus according to the present invention includes a similar case search unit configured to search for similar case data, which is medical case data including examination information similar to examination information of a medical practice target in characteristics, from a medical case data storage unit that stores medical case data including examination information of a subject associated with medical practice difficulty level information based on the examination information. The information processing apparatus further includes a display mode determination unit configured to determine a display mode applicable to the similar case data based on a medical practice difficulty level of the similar case data, and a display unit configured to display the similar case data according to the display mode determined by the display mode determination unit.

Further features and aspects of the present invention will become apparent from the following detailed description of exemplary embodiments with reference to the attached drawings, in which like reference characters designate the same or similar parts throughout the figures thereof.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic view illustrating an example of a schematic configuration of an information processing system according to a first exemplary embodiment of the present invention.

FIG. 2 is a flowchart illustrating an example of a processing procedure of an information processing method, which can be performed by an information processing apparatus according to the first exemplary embodiment of the present invention.

FIG. 3 is a schematic view illustrating an example content of medical case data stored in a case database illustrated in FIG. 1 according to the first exemplary embodiment of the present invention.

FIG. 4 is a schematic view illustrating an example of a display mode M₁ according to the first exemplary embodiment of the present invention, which is employable when a first medical examination flag F is “True” (i.e., first medical examination) and a display recommendation level P satisfies a relationship P<T.

FIG. 5 is a schematic view illustrating an example of a display mode M₂ according to the first exemplary embodiment of the present invention, which is employable when the first medical examination flag F is “True” (i.e., the first medical examination) and the display recommendation level P satisfies a relationship P≧T.

FIG. 6 is a schematic view illustrating an example of a display mode M₃ according to the first exemplary embodiment of the present invention, which is employable when the first medical examination flag F is “False” (i.e., other than the first medical examination) and the display recommendation level P satisfies a relationship P<T.

FIG. 7 is a schematic view illustrating an example of a display mode M₄ according to the first exemplary embodiment of the present invention, which is employable when the first medical examination flag F is “False” (i.e., other than the first medical examination) and the display recommendation level P satisfies a relationship P≧T.

FIG. 8 is a schematic view illustrating an example of a display mode M₅ according to the first exemplary embodiment of the present invention, which is employable when the first medical examination flag F is “True” (i.e., the first medical examination) and the display recommendation level P satisfies a relationship P≧T′.

FIG. 9 is a flowchart illustrating an example of a detailed processing procedure of similar case display recommendation level calculation processing that can be executed in step S104 illustrated in FIG. 2.

FIG. 10 is a graph schematically illustrating a correction function u=f(x) that represents an example of correction coefficient “u” in relation to physician's skill level “x”, which can be used to calculate a correction coefficient of a display recommendation level in step S907 illustrated in FIG. 9.

FIG. 11 is a graph schematically illustrating a correction function v=g(y) that represents an example of correction coefficient “v” in relation to difference “y” between diagnostic target image attributes and physician's specialty, which can be used to calculate the correction coefficient of a display recommendation level in step S907 illustrated in FIG. 9.

FIG. 12 is a schematic view illustrating an example of a schematic configuration of an information processing system according to a second exemplary embodiment of the present invention.

FIG. 13 is a flowchart illustrating an example of a processing procedure of an information processing method, which can be performed by an information processing apparatus according to the second exemplary embodiment of the present invention.

FIG. 14 is a flowchart illustrating an example of a detailed processing procedure for calculating similar case display recommendation level that can be executed in step S203 illustrated in FIG. 13.

FIG. 15 is a flowchart illustrating an example of a processing procedure of an information processing method, which can be performed by an information processing apparatus according to a third exemplary embodiment of the present invention.

FIG. 16 is a schematic view illustrating an example content of the medical case data stored in the case database illustrated in FIG. 1 according to the third exemplary embodiment of the present invention.

FIG. 17 is a schematic view illustrating an example of a display mode M₈ according to the third exemplary embodiment of the present invention, which is employable when the first medical examination flag F is “False” (i.e., other than the first medical examination) and a parameter α_{P} of the display recommendation level P satisfies a relationship α_{P}≧T and α_{P}>β_{P}.

FIG. 18 is a schematic view illustrating an example of a display mode M₉ according to the third exemplary embodiment of the present invention, which is employable when the first medical examination flag F is “False” (i.e., other than the first medical examination) and a parameter β_{P} of the display recommendation level P satisfies a relationship β_{P}≧T and β_{P}≧α_{P}.

FIG. 19 is a schematic view illustrating an example of a hardware configuration of an information processing system according to a fourth exemplary embodiment of the present invention.

### DESCRIPTION OF THE EMBODIMENTS

Various exemplary embodiments, features, and aspects of the invention will be described in detail below with reference to the drawings.

A first exemplary embodiment of the present invention is described below.

In the present exemplary embodiment, it is assumed that an information processing system includes a case database that stores medical case data, in which examination information (including medical images of a subject (patient)) is associated with information representing the difficulty of a medical practice (a diagnostic practice in the present exemplary embodiment) based on the examination information. In the present exemplary embodiment, the difficulty of a diagnostic practice that can be used in the present exemplary embodiment is defined as a “diagnostic difficulty level.”

Further, in the present exemplary embodiment, the information processing system searches for a similar case from the case database, before displaying a diagnosis dedicated screen, and determines a recommendation degree of presenting the similar case based on a “diagnostic difficulty level” of the searched similar case. Then, the information processing system determines a display mode for the similar case based on the determined recommendation degree.

The “diagnostic difficulty level” of a medical case relating to a medical image similar to a diagnostic target medical image corresponds to a “diagnostic difficulty level” of the diagnostic target medical image. It is presumed that the necessity of presenting the similar case is variable depending on the “diagnostic difficulty level.”

Thus, the information processing system according to the present exemplary embodiment can realize an appropriate presentation of medical information for a physician considering the necessity of presenting a similar case based on a diagnostic difficulty in each diagnostic practice. In the present exemplary embodiment, the degree of recommending the presentation of a similar case is defined as a “display recommendation level.”

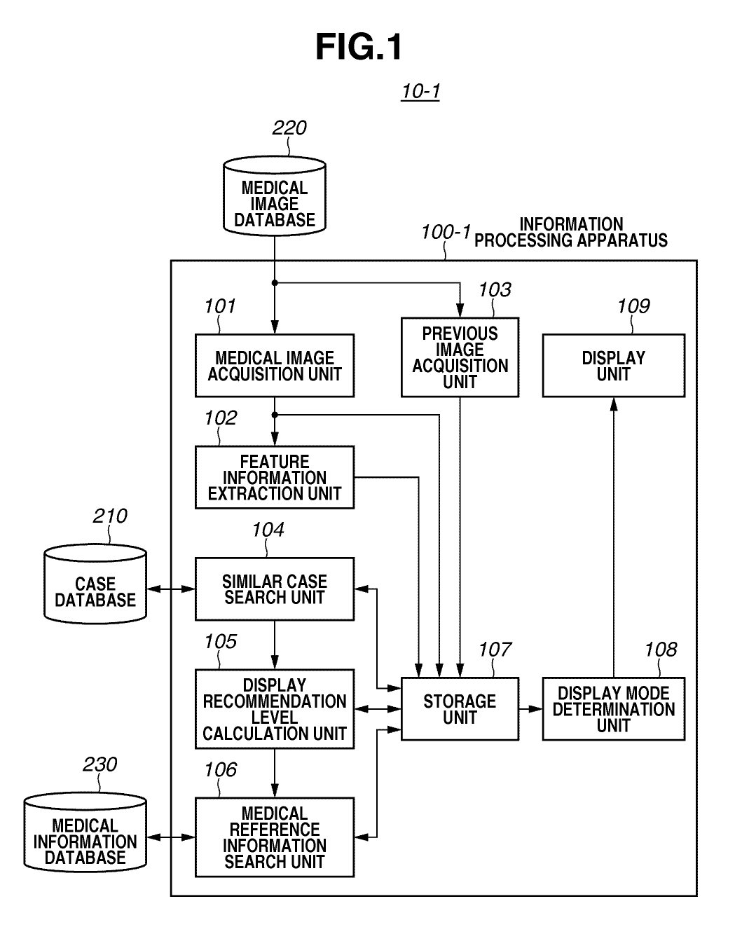

FIG. 1 is a block diagram illustrating an example of a schematic configuration of an information processing system 10-1 according to the first exemplary embodiment of the present invention. The information processing system 10-1, as illustrated in FIG. 1, includes an information processing apparatus 100-1, a case database 210, a medical image database 220, and a medical information database 230.

The information processing apparatus 100-1 performs processing for medical case data including examination information of various subjects (patients). The case database 210 is a medical case data storage unit configured to store medical case data, which include examination information of subjects in association with medical practice difficulty level information based on the examination information. More specifically, the case database 210 stores medical case data relating to medical practice completed (e.g., diagnosis completed and treatment completed) medical cases.

The medical image database 220 is a medical image storage unit configured to store image information relating to medical images captured by a medical imaging apparatus (not illustrated). A conventional Picture Archiving and Communication System (PACS) is an example of the medical image database 220.

Considering differences in their types, the medical images can be classified, for example, into simple X-ray images (roentgen images), X-ray CT images, MRI images, Positron Emission Tomography (PET) images, Single Photon Emission Computed Tomography (SPECT) images, and ultrasonic wave images. Further, the image information relating to medical images stored in the medical image database 220 includes not only medical images but also additional information attached to the medical images.

For example, when the medical image is a chest X-ray CT image, the additional information stored in the medical image database 220 includes photographing information, such as photographing date and time, photographing modality (X-ray CT), photographed region (chest), and photographing conditions.

The medical information database 230 is a medical information storage unit configured to store medical information. The medical information is, for example, fundamental information relating to a concerned disease and reference information including contents of medical magazines and Journals of various institutes. The medical information database 230 can include any information available on the web as a database when the Internet search is feasible.

The information processing apparatus 100-1 includes a medical image acquisition unit 101, a feature information extraction unit 102, a previous image acquisition unit 103, a similar case search unit 104, a display recommendation level calculation unit 105, a medical reference information search unit 106, a storage unit 107, a display mode determination unit 108, and a display unit 109.

The medical image acquisition unit 101 is functionally configured to acquire, from the medical image database 220, image information relating to medical images of subjects respectively serving as a target in a medical practice (e.g., a diagnosis or a treatment). In the present exemplary embodiment, each medical image of a subject serving as a target in a medical practice is referred to as a “medical practice target image.” Further, in the present exemplary embodiment, the diagnostic practice is an example of the medical practice and a medical image of a subject serving as a target in the diagnostic practice is referred to as a “diagnostic target image.”

The feature information extraction unit 102 is functionally configured to extract image feature information from a medical practice target image acquired by the medical image acquisition unit 101 (i.e., a diagnostic target image in the present exemplary embodiment).

The previous image acquisition unit 103 is functionally configured to acquire, from the medical image database 220, image information relating to previous images of a patient among the medical practice target images (i.e., the diagnostic target images in the present exemplary embodiment).

The similar case search unit 104 is functionally configured to search for similar case data, from the case database 210, as medical case data including examination information that is similar to that of a medical practice target in characteristics.

The display recommendation level calculation unit 105 is functionally configured to calculate a display recommendation level of the similar case data based on a medical practice difficulty level of the similar case data searched by the similar case search unit 104 (i.e., the diagnostic difficulty level in the present exemplary embodiment).

The medical reference information search unit 106 is functionally configured to search medical reference information, such as disease information, from the medical information database 230. The storage unit 107 stores various types of information acquired by the medical image acquisition unit 101, the feature information extraction unit 102, the previous image acquisition unit 103, the similar case search unit 104, the display recommendation level calculation unit 105, and the medical reference information search unit 106.

The display mode determination unit 108 is functionally configured to determine a display mode applicable to the similar case data based on a medical practice difficulty level of the similar case data searched by the similar case search unit 104 (i.e., the diagnostic difficulty level in the present exemplary embodiment).

More specifically, the display mode determination unit 108 determines a display mode applicable to the similar case data referring to a display recommendation level calculated by the display recommendation level calculation unit 105 based on the medical practice difficulty level (i.e., the diagnostic difficulty level in the present exemplary embodiment).

The display unit 109 is functionally configured to display similar case data according to the display mode determined by the display mode determination unit 108.

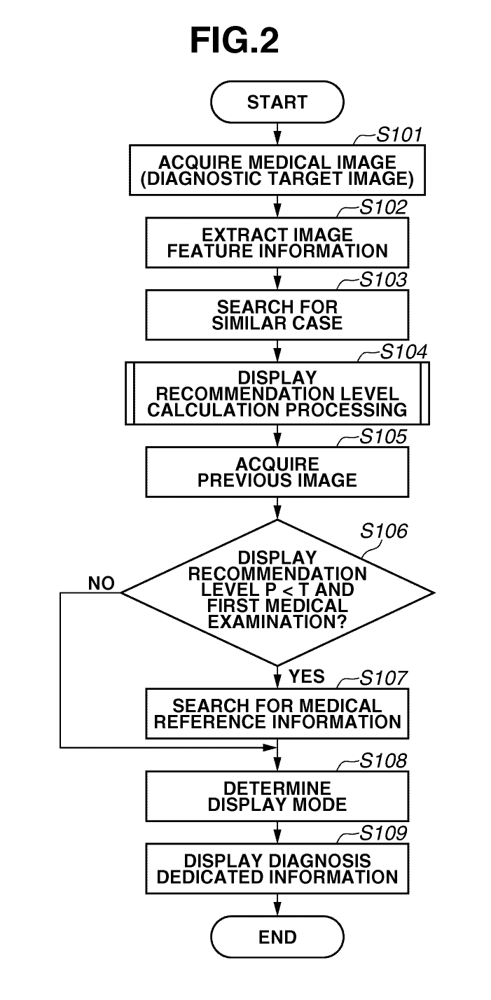

Next, an example operation that can be performed by each functional unit of the information processing apparatus 100-1 according to the first exemplary embodiment is described below with reference to FIG. 2. FIG. 2 is a flowchart illustrating an example of a processing procedure of an information processing method, which can be performed by the information processing apparatus 100-1 according to the first exemplary embodiment of the present invention.

First, in step S101 illustrated in FIG. 2, the medical image acquisition unit 101 acquires, from the medical image database 220, image information relating to a diagnostic target image (i.e., a medical image of an image diagnostic target designated by a physician).

Then, the medical image acquisition unit 101 transmits the acquired image information relating to the diagnostic target image to the feature information extraction unit 102 and the storage unit 107.

Subsequently, in step S102, the feature information extraction unit 102 acquires the image information relating to the diagnostic target image from the medical image acquisition unit 101. Then, the feature information extraction unit 102 extracts image feature information from the medical image (i.e., the diagnostic target image) included in the image information acquired from the medical image acquisition unit 101.

More specifically, in extracting the image feature information, when an acquired diagnostic target image is a chest X-ray CT image, the feature information extraction unit 102 detects an affected part through image analysis performed on the chest X-ray CT image and sets an area surrounding the affected part.

The feature information extraction unit 102 defines the extracted area as a “concerned area.” Then, the feature information extraction unit 102 extracts image feature information relating to the affected part from the “concerned area” having been set. For example, when the affected part is a solitary nodule shade, the feature information extraction unit 102 extracts size information of the affected part (e.g., diameter (major diameter/minor diameter/average diameter) and area), shape features of the affected part (e.g., ratio of major diameter to minor diameter, ratio of border line length to average diameter, and fractal dimension of border line), average density of the affected part, and density distribution pattern of the affected part. The feature information extraction unit 102 can extract other various image feature information.

Then, the feature information extraction unit 102 transmits the image feature information extracted from the diagnostic target image to the storage unit 107.

Subsequently, in step S103, the similar case search unit 104 acquires the image feature information relating to the diagnostic target image stored in the storage unit 107 in step S102. Next, the similar case search unit 104 performs similar case search processing to extract, from the case database 210, medical case data having image feature information similar to the acquired image feature information relating to the diagnostic target image (which may be referred to as a similar case search step).

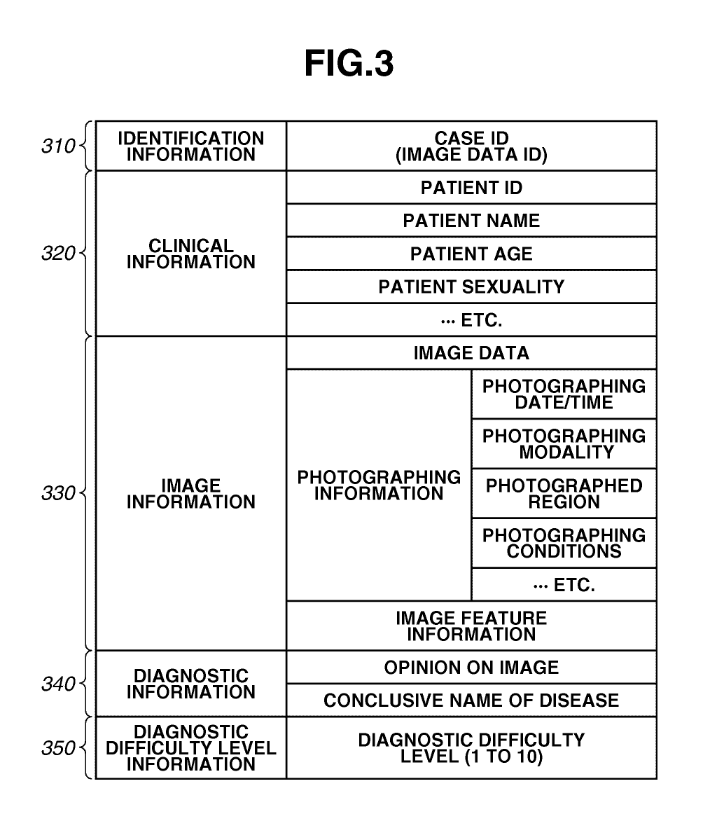

FIG. 3 is a schematic view illustrating an example content of the medical case data stored in the case database 210 illustrated in FIG. 1 according to the first exemplary embodiment of the present invention.

As illustrated in FIG. 3, the medical case data stored in the case database 210 according to the present exemplary embodiment includes identification information 310, clinical information 320, image information 330, diagnostic information 340, and diagnostic difficulty level information 350.

More specifically, the medical case data according to the present exemplary embodiment includes examination information of a subject, which is, for example, composed of the identification information 310, the clinical information 320, the image information 330, and the diagnostic information 340. The examination information of each subject is stored in association with the diagnostic difficulty level information 350 that represents a medical practice difficulty level.

More specifically, information being set as the identification information 310 includes a case ID corresponding to a medical image of a diagnostic target (i.e., an image data ID). Further, the clinical information 320 includes information relating to a diagnostic target patient (i.e., a subject), such as patient ID, patient name, patient age, and patient sexuality.

Further, information being set as the image information 330 includes image data of a medical image, photographing information, and image feature information extracted from the medical image. Information being set as the photographing information includes photographing date and time, photographing modality, photographed region, and photographing conditions.

Further, information being set as the diagnostic information 340 includes opinion on image and conclusive name of disease. Further, the diagnostic difficulty level information 350 includes a diagnostic difficulty level (1 to 10) indicating a difficulty level of a diagnostic practice corresponding to the medical image.

In the present exemplary embodiment, the diagnostic difficulty level (1 to 10) illustrated in FIG. 3 is a mere example and any numerical values (e.g., 0.0 to 1.0) representing the diagnostic difficulty level can be used.

Next, an example of a similar case search operation is described below. It is now assumed that image feature information obtained from a diagnostic target image is pulmonary nodule shade. In this case, first, the similar case search unit 104 generates a feature information vector including the above-described image feature information as an element.

Further, as illustrated in FIG. 3, the case database 210 stores image feature information of each medical case data. Therefore, for example, the similar case search unit 104 generates a feature vector corresponding to each medical case data. Then, the similar case search unit 104 acquires, as a search result, medical case data fairly similar to the diagnostic target image in a feature space having axes corresponding to respective elements of the generated feature information vector.

Fₜ={fₜ¹,fₜ²,Λ,fₜ^{m}} (1)

Fᵢ={fᵢ¹,fᵢ²,Λ,fᵢ^{m}} (2)

In the above-described formulae (1) and (2), “m” represents the number of vector elements. Further, the similar case search unit 104 defines a similarity level Sᵢ based on the Euclidean distance of the feature vector Fᵢ of the i-th medical case data relative to the feature information vector Fₜ of the diagnostic target image, using the following formula (3).

$${S}_{i} = \frac{1}{1 + \sqrt{{\sum }_{j = 1}^{m} {( {f}_{t}^{j} - {f}_{i}^{j} )}^{2}}} \qquad ( 3 )$$

Then, the similar case search unit 104 calculates the similarity level Sᵢ for every “i” that satisfies a relationship 1≦i≦N when N represents the total number of medical case data stored in the case database 210. The similar case search unit 104 acquires k (constant) pieces of medical case data which have the highest and succeeding higher values with respect to the similarity level Sᵢ, and designates the acquired medical case data as similar cases. In the present exemplary embodiment, the constant k is, for example, equal to 3 (i.e., k=3).

Then, the similar case search unit 104 transmits the k pieces of similar case data acquired by the similar case search processing to the display recommendation level calculation unit 105 and the storage unit 107.

Subsequently, in step S104, the display recommendation level calculation unit 105 acquires the similar case data from the similar case search unit 104. Then, the display recommendation level calculation unit 105 calculates a display recommendation level P of the similar case based on a diagnostic difficulty level in the acquired similar case data.

Then, the display recommendation level calculation unit 105 transmits the calculated display recommendation level P to the medical reference information search unit 106 and the storage unit 107.

Subsequently, in step S105, the previous image acquisition unit 103 acquires image information relating to previous images of a patient in the diagnostic target image from the medical image database 220. In this case, for example, the previous image acquisition unit 103 acquires a patient ID of the diagnostic target image having been input in the medical image acquisition unit 101. The previous image acquisition unit 103 searches for the image information of the previous images that are relevant to the acquired patient ID.

Therefore, in a case where the image diagnosis for the same patient has been performed at least one time, the previous image acquisition unit 103 can acquire image information of previous image (s) relating to the patient. In this case, if it is determined that there is not any previous image acquired through the search on the medical image database 220, the previous image acquisition unit 103 sets a flag indicating the first medical examination (hereinafter, referred to as “first medical examination flag”) F to “True.”

On the other hand, if it is determined that there is at least one previous image acquired through the search on the medical image database 220, the previous image acquisition unit 103 sets the first medical examination flag F to “False.”

Then, the previous image acquisition unit 103 transmits the acquired image information of previous images and the set value of the first medical examination flag F to the storage unit 107.

Subsequently, in step S106, the medical reference information search unit 106 acquires the display recommendation level P from the display recommendation level calculation unit 105 and the set value of the first medical examination flag F from the storage unit 107. Then, the medical reference information search unit 106 determines whether the value of the acquired display recommendation level P is less than a first threshold T (P<T) and the first medical examination flag F is “True” (i.e., the first medical examination).

Then, if it is determined that the value of the acquired display recommendation level P is less than the first threshold T and the first medical examination flag F is “True” (YES in step S106), the processing proceeds to step S107. On the other hand, if it is determined that the value of the acquired display recommendation level P is equal to or greater than the first threshold T or if it is determined that the first medical examination flag F is not “True” (NO in step S106), the processing directly proceeds to step S108.

In the present exemplary embodiment, a setting value of the first threshold T is equal to 0.5 (i.e., T=0.5). The determination processing of step S106 indicates that medical reference information search processing (i.e., processing in step S107) is performed only when the display recommendation level P of the diagnostic target image is less than the first threshold T and the preset image diagnosis is the first medical examination.

If it is determined that the diagnosis on a diagnostic target image is easier than a predetermined standard defined based on the first threshold T, it can be regarded that presenting a similar case as a reference is unnecessary. Further, there is not any previous image(s) when the image diagnosis is the first medical examination. Therefore, a surplus display area can be effectively used for other purposes.

Further, even in a case where the diagnosis is easy, presenting medical reference information relating to an estimated disease enables users to refer to various types of expertise information including the latest information relating to the concerned disease. In this respect, presenting the medical reference information is meaningful.

As described above, if it is determined that the value of the display recommendation level P is less than the first threshold T and the preset image diagnosis is the first medical examination (YES in step S106), the processing proceeds to step S107. When the processing proceeds to step S107, the medical reference information search unit 106 acquires image information of the diagnostic target image from the storage unit 107 and searches for medical reference information of the disease from the medical information database 230.

For example, in a case where the feature information extraction unit 102 extracts the “concerned area” of a pulmonary nodule shade together with image feature information from the diagnostic target image, the medical reference information search unit 106 acquires observational information commenting that the extracted information indicates the “pulmonary nodule shade.”

Then, the medical reference information search unit 106 searches for medical reference information relating to any disease (e.g., primary lung cancer, metastatic lung cancer, or benign tumor) which can be estimated based on the observational information from the medical information stored in the medical information database 230.

In the present exemplary embodiment, the medical information database 230 is a database that stores medical information as described above. The medical information stored in the medical information database 230 includes, for example, disease related fundamental information (e.g., diseased region, cause of disease, condition of patient, diagnosis method, treatment method, and cautions in diagnosis and treatment) and reference information including contents of medical magazines and Journals of various institutes.

Then, the medical reference information search unit 106 transmits the acquired medical reference information to the storage unit 107.

As described above, if it is determined that the value of the display recommendation level P is not less than the first threshold T or the preset image diagnosis is not the first medical examination (NO in step S106), the processing proceeds to step S108. Further, after completion of the processing in step S107, the processing proceeds to step S108.

When the processing proceeds to step S108, the display mode determination unit 108 acquires, from the storage unit 107, image information of the diagnostic target image, image information of previous image(s), similar case data, medical reference information, and values of the first medical examination flag F and the display recommendation level P.

Next, the display mode determination unit 108 determines a display mode M (M is any one of M₁ to M₆) for displaying the contents of the acquired image information of the diagnostic target image, image information of previous image(s), similar case data, and medical reference information, based on the acquired values of the first medical examination flag F and the display recommendation level P. The step S108 can be referred to as a “display mode determination step.”

Then, the display mode determination unit 108 transmits, to the display unit 109, information relating to the determined display mode M in addition to the information acquired from the storage unit 107 including the image information of the diagnostic target image, image information of previous image(s), similar case data, and medical reference information.

Subsequently, in step S109, the display unit 109 receives the value relating to the display mode M (i.e., any one of M₁ to M₆) as well as the image information of the diagnostic target image, image information of previous image(s), similar case data, and medical reference information, which are transmitted from the display mode determination unit 108.

Then, the display unit 109 displays the acquired diagnosis dedicated information including the image information of the diagnostic target image, image information of previous image(s), similar case data, and medical reference information, on a diagnosis dedicated screen of a monitor (not illustrated), according to the acquired display mode M (which can be referred to as a display step). Therefore, the physician can diagnose the disease of the patient (i.e., subject) while viewing the diagnosis dedicated information displayed on the diagnosis dedicated screen of the monitor (not illustrated).

When the processing of step S109 is completed, the information processing apparatus 100-1 terminates the processing of the information processing method according to the first exemplary embodiment illustrated in FIG. 2.

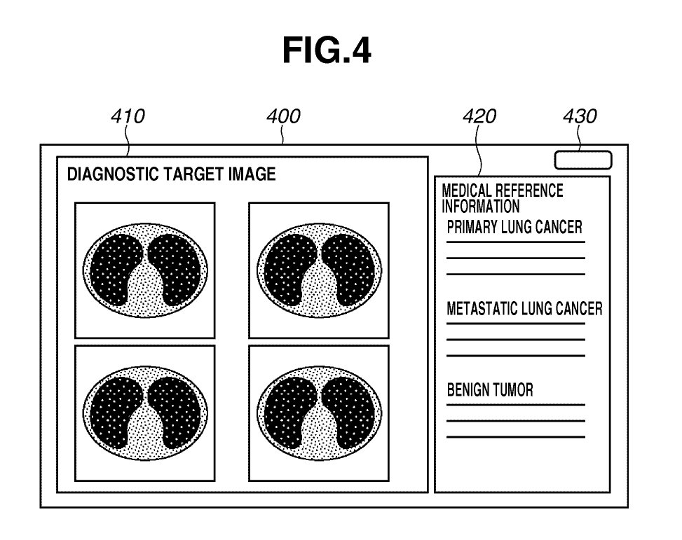

Next, the display mode M determined in step S108 is described below in more detail with reference to FIG. 4 to FIG. 8.

FIG. 4 is a schematic view illustrating an example of a display mode M₁ according to the first exemplary embodiment of the present invention, which is employable when the first medical examination flag F is “True” (i.e., first medical examination) and the display recommendation level P is less than the first threshold (i.e., P<T).

A diagnosis dedicated screen 400 illustrated in FIG. 4 includes a diagnostic target image display area 410 positioned on the left side, a medical reference information display area 420 on the right side, and a similar case display button 430 located at an upper right corner. The reason why similar cases are not present on the diagnosis dedicated screen 400 is because presenting the similar cases may be unnecessary if the diagnosis on the diagnostic target image is easy, as described in step S106.

More specifically, usage of the display mode M₁ illustrated in FIG. 4 is effective when the diagnosis is easy because physicians are not bothered by unnecessarily displayed similar case(s). Further, presenting medical reference information on the right side of the diagnosis dedicated screen 400 is an example of effective use of a surplus display area on the screen, as described in step S106.

Further, if the similar case display button 430 is pressed, the diagnosis dedicated screen 400 replaces the medical reference information display area 420 with a display of similar cases or newly displays another similar case display screen. In other words, the display of similar case(s) is performed only when it is required by each physician.

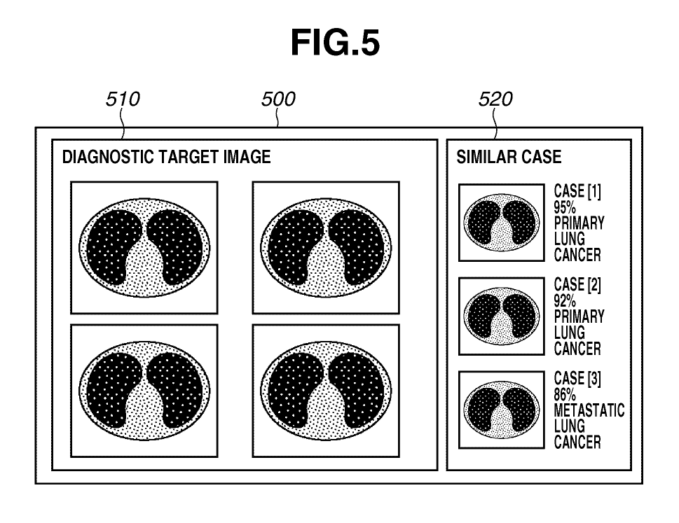

FIG. 5 is a schematic view illustrating an example of a display mode M₂ according to the first exemplary embodiment of the present invention, which is employable when the first medical examination flag F is “True” (i.e., the first medical examination) and the display recommendation level P is equal to or greater that the first threshold (i.e., P≧T).

A diagnosis dedicated screen 500 illustrated in FIG. 5 includes a diagnostic target image display area 510 positioned on the left side and a similar case display area 520 on the right side. As illustrated in FIG. 5, a list of a plurality of medical cases is displayed in the similar case display area 520, in which the number of medical cases is three (k=3) and the displayed cases [1] to [3] are arranged in descending order of magnitude with respect to the similarity level.

Usage of the display mode M₂ illustrated in FIG. 5 is effective when the display recommendation level P is equal to or greater than a predetermined value. More specifically, when the diagnosis on a diagnostic target image is difficult, presenting similar cases is desired because it is helpful for a physician's diagnostic practice.

Further, when the diagnosis is difficult, practical data of similar cases will be greatly helpful as reference information in the diagnosis rather than general information about diseases. Therefore, the display mode M₂ illustrated in FIG. 5 includes the similar case display area 520 as a counterpart comparable to the medical reference information display area 420 illustrated in FIG. 4.

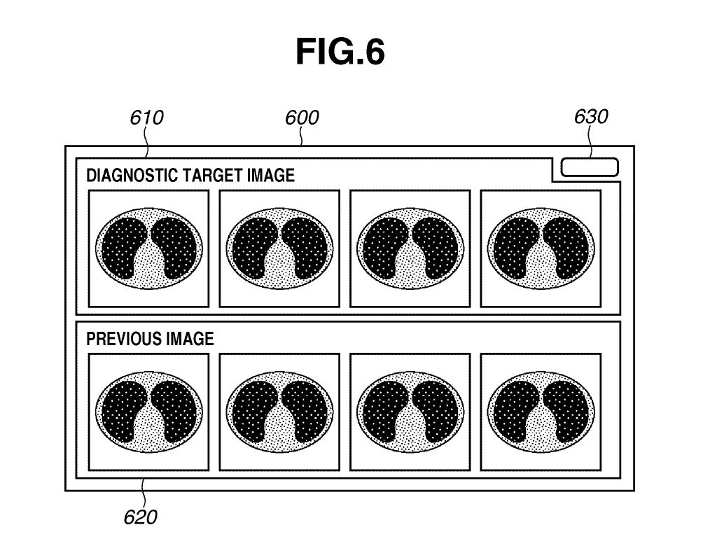

FIG. 6 is a schematic view illustrating an example of a display mode M₃ according to the first exemplary embodiment of the present invention, which is employable when the first medical examination flag F is “False” (i.e., other than the first medical examination) and the display recommendation level P is less than the first threshold (i.e., P<T).

A diagnosis dedicated screen 600 illustrated in FIG. 6 includes a diagnostic target image display area 610 positioned on the upper side, a previous image display area 620 on the lower side, and a similar case display button 630 located at an upper right corner.

The display mode M₃ illustrated in FIG. 6 does not include any display of similar cases. Therefore, similar to the display mode M₁ illustrated in FIG. 4, not only physicians are not bothered by unnecessarily displayed similar case(s) but also the display area can be effectively used for the display of previous images.

Further, if the similar case display button 630 is pressed, the diagnosis dedicated screen 600 reduces the number of diagnostic target images and previous images to be displayed and newly displays similar cases on the right side or another similar case display screen. Thus, similar to the display mode M₁ illustrated in FIG. 4, the display of similar case(s) is performed only when it is required by each physician.

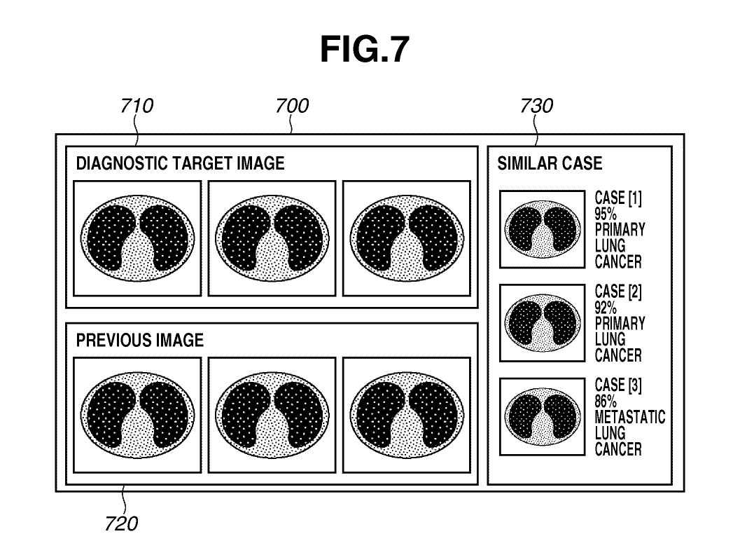

FIG. 7 is a schematic view illustrating an example of a display mode M₄ according to the first exemplary embodiment of the present invention, which is employable when the first medical examination flag F is “False” (i.e., other than the first medical examination) and the display recommendation level P is equal to or greater than the first threshold (i.e., P≧T).

A diagnosis dedicated screen 700 illustrated in FIG. 7 includes a diagnostic target image display area 710 positioned on the upper left side, a previous image display area 720 on the lower left side, and a similar case display area 730 on the right side.

As illustrated in FIG. 7, similar to the example, a list of a plurality of medical cases is displayed in the similar case display area 730, in which the number of medical cases is three (k=3) and the displayed cases [1] to [3] are arranged in descending order of magnitude with respect to the similarity level.

Usage of the display mode M₄ illustrated in FIG. 7 is effective when the diagnosis on a diagnostic target image is difficult and presenting similar cases is helpful for a physician's diagnostic practice. Further, even when the diagnosis is difficult, the display mode M₄ displays both of previous images and similar cases considering the necessity of previous images.

Further, according to the above-described example, when similar cases are displayed, a list of medical images of the similar cases is displayed along a vertical line as illustrated in FIG. 5 (the display mode M₂) or in FIG. 7 (the display mode M₄). However, the method for displaying similar cases is not limited to the above-described examples.

For example, it is useful to arrange similar cases in descending order of magnitude with respect to the similarity level for each classified disease. In this case, display modes M₅ and M₆ can be obtained by modifying the display modes M₂ and M₄ so as to classify the cases for each disease.

However, in this case, the similar case display area of the display modes M₅ and M₆ is greater than that of the display modes M₂ and M₄. In other words, the display modes M₅ and M₆ cannot provide a larger display area for the diagnostic target images and previous images. Therefore, the display modes M₅ and M₆ are employable when the display recommendation level P is relatively high.

More specifically, in the present exemplary embodiment, a second threshold T′ is used as another threshold that is larger than the first threshold T (T′>T). If the display recommendation level is equal to or greater than the second threshold (P≧T′), the display modes M₅ and M₆ are employable. In the present exemplary embodiment, for example, a setting value of the second threshold T′ is equal to 0.8 (i.e., T′=0.8).

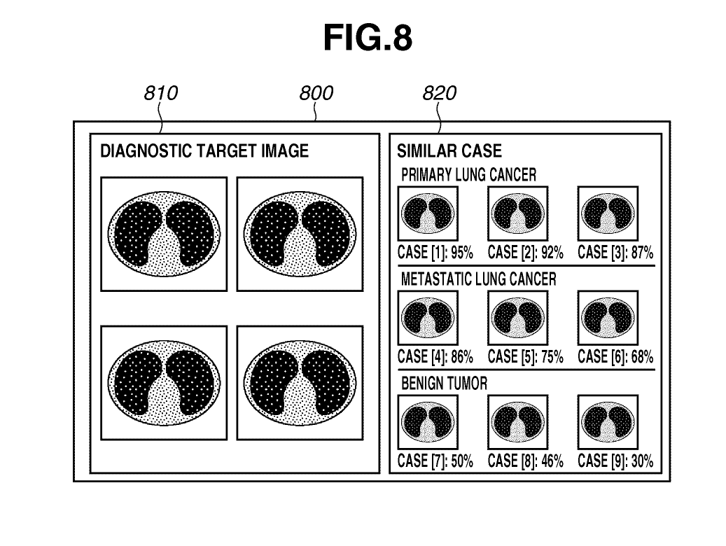

FIG. 8 is a schematic view illustrating an example of the display mode M₅ according to the first exemplary embodiment of the present invention, which is employable when the first medical examination flag F is “True” (i.e., the first medical examination) and the display recommendation level P is equal to or greater than the second threshold (i.e., P≧T′).

A diagnosis dedicated screen 800 illustrated in FIG. 8 includes a diagnostic target image display area 810 positioned on the left side and a similar case display area 820 on the right side. As illustrated in FIG. 8, a list of a plurality of medical cases is displayed in the similar case display area 820, in which the number of medical cases is nine (k=9) and the displayed cases [1] to [9] are arranged in descending order of magnitude with respect to the similarity level in each classification of the disease.

Further, the display mode M₆ is not different from the display mode M₅ in the way of displaying similar cases, although not described in detail. As described above, the display mode displaying similar cases for each classified disease enables each physician to compare a diagnostic target image with an assembly of similar cases classified into the same disease group and determine the disease of the diagnostic target image referring to the presented useful information.

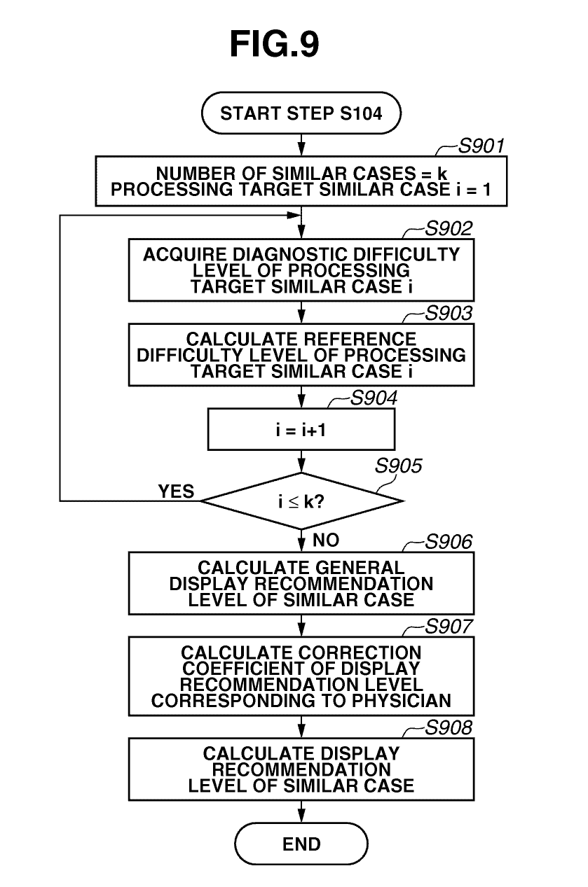

Next, processing for calculating the similar case display recommendation level to be executed in step S104 illustrated in FIG. 2 is described below in more detail. FIG. 9 is a flowchart illustrating an example of a detailed procedure of the processing for calculating the similar case display recommendation level that can be executed in step S104 illustrated in FIG. 2.

After starting the processing of step S104 illustrated in FIG. 2, first, in step S901 illustrated in FIG. 9, the display recommendation level calculation unit 105 sets k as a parameter representing the total number of similar cases and initializes a parameter i representing the present processing target similar case (i=1). In this case, for example, it is assumed that processing target similar cases are arranged in descending order of magnitude with respect to the similarity level.

Subsequently, in step S902, the display recommendation level calculation unit 105 acquires a diagnostic difficulty level of medical case data relating to similar case from similar case data acquired by the similar case search unit 104. In this case, Dᵢ represents the diagnostic difficulty level of the acquired similar case i.

Subsequently, in step S903, the display recommendation level calculation unit 105 calculates a reference difficulty level Rᵢ corresponding to the diagnostic difficulty level Dᵢ of the similar case i, so as to reflect a reference level of the similar case i relative to the diagnostic target image.

The obtained reference difficulty level Rᵢ can be referred to when the display recommendation level P of the similar case is calculated, to change a weighting of the similar case considering the reference level of the similar case.

The reference difficulty level Rᵢ can be obtained by weighting the diagnostic difficulty level Dᵢ with the reference level of the similar case i relative to the diagnostic target image. When a medical image of the similar case i is substantially the same as the diagnostic target image, the similar case i can be considered as a good reference for the diagnostic target image.

Hence, the reference level of the similar case relative to the diagnostic target image can be defined as follows.

(Reference level of similar case i relative to diagnostic target image)=(Similarity level of similar case i relative to diagnostic target image)

Accordingly, when Sᵢ represents the similarity level of the similar case i relative to the diagnostic target image, the following formula (4) can be used to obtain the reference difficulty level Rᵢ.

Rᵢ=Dᵢ·Sᵢ (4)

Subsequently, in step S904, the display recommendation level calculation unit 105 increments the variable “i” representing the present processing target similar case by one, i.e., i=i+1. Accordingly, the present processing target similar case i can be updated and newly set.

Subsequently, in step S905, the display recommendation level calculation unit 105 compares the present processing target similar case i with the total number of similar cases k and determines whether the value i is equal to or less than the value k (i.e., i≦k).

If it is determined that the value i is equal to or less than the value k, i.e., i k (YES in step S905), the processing returns to step S902 and the above-described processing of steps S902 to S905 is repeated. On the other hand, if it is determined that the value i is greater than the value k, i.e., i>k (NO in step S905), the processing proceeds to step S906.

When the processing proceeds to step S906, the display recommendation level calculation unit 105 calculates a general display recommendation level Pₛₜ of the similar case based on the reference difficulty level Rᵢ of each similar case “i” calculated in the processing of step S905 and preceding steps.

In the present exemplary embodiment, the “general display recommendation level” represents the degree of recommending the presentation of a similar case as a reference for the diagnostic target image. The “general display recommendation level” does not depend on each physician who performs diagnosis.

The meaning of the processing of step S906 is that the reference value of the “diagnostic difficulty level” of a similar case resembling the diagnostic target image corresponds to a general diagnosis difficulty of the diagnostic target image and is applicable as the “general display recommendation level” of the similar case.

According to an example method for calculating the general display recommendation level Pₛₜ, for example, a reference difficulty level of a similar case having the highest value in the reference difficulty level among a plurality of similar cases is applied as the general display recommendation level Pₛₜ of the similar case. More specifically, the following formula (5) can be used to obtain the general display recommendation level Pₛₜ.

$${P}_{st} = {max}_{1 \leq i \leq k} \{ {R}_{i} \} \qquad ( 5 )$$

If at least one similar case having a higher reference difficulty level is present among the plurality of similar cases, necessity of presenting the similar case(s) to the physician increases. More specifically, increasing the general display recommendation level may be necessary.

However, the method for calculating the general display recommendation level Pₛₜ is not limited to the above-described method. For example, considering differences in the reference difficulty level among all similar cases, it is useful to set an average value of the reference difficulty level Rᵢ as the general display recommendation level Pₛₜ. In this case, the following formula (6) can be used to obtain the general display recommendation level Pₛₜ.

$${P}_{st} = \frac{1}{k} \cdot {\sum }_{i = 1}^{k} {R}_{i} \qquad ( 6 )$$

Subsequently, in step S907, the display recommendation level calculation unit 105 calculates a correction coefficient of a display recommendation level that reflects the ability (e.g., skill level and specialty) of a physician who performs diagnostic practice. In general, even when the medical case is the same, an evaluation level of the difficulty is variable depending on the ability (e.g., skill level and specialty) of each physician. Accordingly, the necessity of presenting similar case(s) is variable depending on each physician.

In step S907, the display recommendation level calculation unit 105 acquires information relating to the ability (e.g., skill level and specialty) of the physician who performs diagnosis. More specifically, the display recommendation level calculation unit 105 acquires information relating to the physician's skill level with respect to image diagnosis (e.g., total number of diagnostic practices conducted for each diagnostic difficulty level) and information relating to the physician's specialty (e.g., posted medical practice department/specialized modality/specialized region).

In the present exemplary embodiment, the number of diagnostic practices conducted for each diagnostic difficulty level is a value representing the number of diagnosed medical cases as physician's experience in each diagnostic difficulty level of the medical case. The number of diagnostic practices conducted for each diagnostic difficulty level can be, for example, calculated by extracting only the medical cases whose images have been diagnosed by the physician, from the medical case data stored in the case database 210, and counting the frequency of appearance for each diagnostic difficulty level of the medical case.

Further, the acquired information can be stored as user information of the information processing apparatus 100-1, for each physician beforehand, in a magnetic disk incorporated in the information processing apparatus. A log-in user (i.e., each physician) of the information processing apparatus can acquire necessary information loaded from the magnetic disk.

Next, an example method for calculating a correction coefficient of the display recommendation level based on information relating to the acquired physician's skill level and specialty is described below.

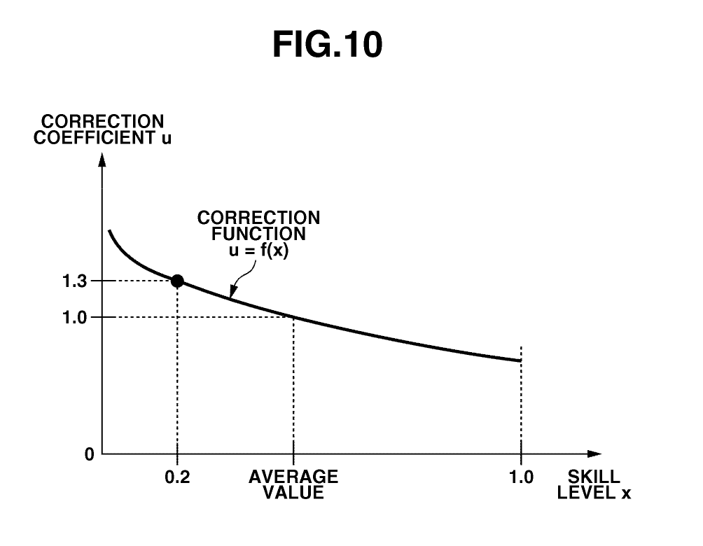

FIG. 10 is a graph schematically illustrating a correction function u=f(x) that represents an example of correction coefficient “u” in relation to physician's skill level “x”, which can be used to calculate a correction coefficient of the display recommendation level in step S907 illustrated in FIG. 9.

The skill level “x” can be calculated, for example, using the following method. When the diagnostic difficulty level is expressed as a value selected from 1 to 10, n₁ to n₁₀ represent the number of diagnostic practices conducted by a physician for each diagnostic difficulty level. In this case, the following formula (7) can be used to obtain a “weighted number of diagnostic practices” N that is obtainable by weighting the total number of diagnostic practices with the diagnostic difficulty level.

$$N = {\sum }_{i = 1}^{10} i \cdot {n}_{i} \qquad ( 7 )$$

Further, when Nₘₐₓ represents an upper limit value of the weighted number of diagnostic practices, the following formula (8) can be used to obtain the skill level “x.”

$$\{ \begin{matrix}x = \frac{N}{{N}_{max}} & ( 0 \leq N \leq {N}_{max} ) \\ x = 1 & ( N > {N}_{max} )\end{matrix} \qquad ( 8 )$$

In the present exemplary embodiment, for example, a setting value of the upper limit value is equal to 10000 (i.e., Nₘₐₓ=10000). The skill level “x” is not limited to the one obtained based on the number of diagnostic practices conducted by a physician for each diagnostic difficulty level. For example, it is useful to calculate the skill level “x” based on years of experience of the physician with respect to image diagnosis. In this case, the skill level “x” can be calculated by replacing N and Nₘₐₓ in the formula (8) by the years of experience of the physician and an upper limit value of the years of experience, respectively.

If a value of the skill level “x” obtained as described above is, for example, equal to or less than an average value (in the present exemplary embodiment, x=0.2), a value of the corresponding correction coefficient “u” can be calculated by inputting the obtained value of the skill level “x” to the correction function f (in this case, u=1.3). If the skill level “x” of a physician with respect to image diagnosis is smaller than the average value, the physician tends to feel difficulty in dealing with a medical case compared to another physician having an average experience. In such a case, the correction coefficient “u” becomes greater than 1.0.

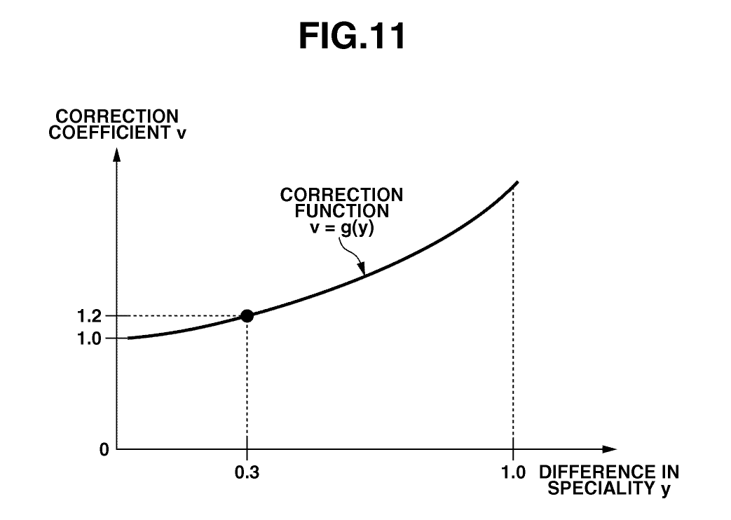

FIG. 11 is a graph schematically illustrating a correction function v=g(y) that represents an example of correction coefficient “v” in relation to difference “y” between diagnostic target image attributes and physician's specialty, which can be used to calculate the correction coefficient of the display recommendation level in step S907 illustrated in FIG. 9.

When all of physician's specialty items (posted medical practice department/specialized modality/specialized region) coincide with the diagnostic target image attributes, the difference “y” is equal to 0. On the other hand, when all of the physician's specialty items do not coincide with the diagnostic target image attributes, the difference “y” is equal to 1.0.

Further, if there is a difference in each item between the diagnostic target image attributes and the physician's specialty, the differences of respective items are added (although the maximum value of an addition value does not exceed 1.0).

For example, it is assumed that the diagnostic target image is a chest X-ray CT image. In this case, for example, if the medical practice department to which the physician is posted is a radiation department, the diagnostic target image attributes coincide with the physician's specialty in the posted medical practice department. Therefore, an addition value “0” is set.

Next, if the medical practice department to which the physician is posted is an internal department or a mammary gland department (i.e., a medical practice department in which image diagnosis may be performed), an addition value “0.2” is set. Further, if the medical practice department to which the physician is posted is any other medical practice department unrelated to image diagnosis, an addition value “0.4” is set.

Further, if the physician's specialized modality is an X-ray CT image, the diagnostic target image attributes coincide with the physician's specialty in the modality. Therefore, an addition value “0” is set. Further, for example, if the physician's specialized modality is an X-ray image (e.g., mammography) or an image (e.g., MRI) relevant to the X-ray CT image, an addition value “0.15” is set. If the physician's specialized modality is any other one (e.g., doing nothing about image diagnosis), an addition value “0.3” is set.

Further, if the physician's specialized region is chest, the diagnostic target image attributes coincide with the physician's specialty in the region. Therefore, an addition value “0” is set. Further, for example, if the physician's specialized region is abdomen, head, or breast, the purpose of performing image diagnosis may be different. Therefore, an addition value “0.15” is set. If the physician's specialized region is any other one (e.g., doing nothing about image diagnosis), an addition value “0.3” is set.

According to the above-described example, when the diagnostic target image is a chest X-ray CT image, if the physician is posted to the radiation department, the physician's specialized modality is MRI, and the physician's specialized region is head, the sum of the addition values is equal to 0.3.

More specifically, the difference “y” is equal to 3 (i.e., y=0.3). A value of the corresponding correction coefficient “v” can be calculated by inputting the obtained value of the difference “y” to the correction function g (in this case, v=1.2). If there is any difference between the diagnostic target image attributes and the physician's specialty, the physician tends to feel difficulty in dealing with a medical case compared to another physician who is perfect in specialty. In such a case, the correction coefficient “v” becomes greater than 1.0.

In the present exemplary embodiment, the correction functions f and g are given beforehand, for example, using the following method.

First, it is assumed that a skill level aⱼ and a difference bⱼ represent discrete values obtainable by dividing respective abscissa axes of FIG. 10 (skill level “x”) and FIG. 11 (difference “y”) at constant intervals, respectively. When “n” is a division number of each abscissa axis, a relationship j n can be satisfied.

In this case, D_{base} represents an average value of the diagnostic difficulty level evaluated by a plurality of physicians who have attributes of skill level “x”=(average value) and difference “y”=0 about the same medical case. The average D_{base} can be referred to as a reference value of the diagnostic difficulty level.

Further, D1ⱼ represents an average value of the diagnostic difficulty level evaluated by a plurality of physicians who have attributes of skill level “x”=aⱼ and difference y=0. Moreover, D2ⱼ represents an average value of the diagnostic difficulty level evaluated by a plurality of physicians who have attributes of skill level “x”=(average value) and difference y=bⱼ.

The method includes obtaining D1ⱼ and D2ⱼ for each j satisfying a relationship 1≦j≦n. The method further includes obtaining a ratio of D_{base} to each of the obtained values D1ⱼ and D2ⱼ to calculate discrete values (correction coefficient uⱼ and vⱼ) on respective ordinate axes of FIG. 10 and FIG. 11.

The following formulae (9) and (10) can be used for the above calculation.

uⱼ=D1ⱼ/D_{base} (9)

vⱼ=D2ⱼ/D_{base} (10)

The method further includes plotting the coordinate points (xⱼ, uⱼ) and (yⱼ, vⱼ) obtained as described above on a graph for each j satisfying 1≦j≦n and performing regression analysis on a combination of the plotted points to obtain the correction function f and g. In the present exemplary embodiment, the least squares method can be used for the regression analysis.

Referring back to FIG. 9, if the processing of step S907 is completed, the processing proceeds to step S908. When the processing proceeds to step S908, the display recommendation level calculation unit 105 corrects the general display recommendation level Pₛₜ calculated in step S906 with the display recommendation level correction coefficients “u” and “v” calculated in step S907, and then calculates a display recommendation level P of the similar case.

In other words, the general display recommendation level Pₛₜ of a similar case, which does not depend on physician's attributes, is corrected according to the physician's attributes to obtain a unique value representing the display recommendation level P of the similar case for each physician.

In this case, the diagnostic difficulty level of the medical case data stored in the case database 210, which serves as a basis in the calculation of the general display recommendation level Pₛₜ, is standardized beforehand so as to eliminate any differences that may arise according to physician's skill level or specialty.

More specifically, a display recommendation level P of an individual similar case corresponding to a physician who performs diagnostic practice can be obtained by calculating a product of the general display recommendation level Pₛₜ of the similar case (i.e., the value standardized beforehand) and the correction coefficients “u” and “v.” Namely, the following formula (II) can be used to calculate the display recommendation level P.

P=u·v·Pₛₜ (11)

In the present exemplary embodiment, it is assumed that P defined by the formula (II) satisfies a relationship 1≦P≦10. If a calculation result of the display recommendation level P obtained by the formula (II) does not satisfy the above-described relationship, the calculation result is replaced by an upper limit value or a lower limit value.

The processing for calculating similar case display recommendation level to be executed in step S104 illustrated in FIG. 2 can be realized by the above-described processing of steps S901 to S908.

As described above, the information processing apparatus 100-1 according to the first exemplary embodiment calculates the display recommendation level P of similar case based on the diagnostic difficulty level of medical case data relating to the similar case and determines a display mode of the similar case in the diagnosis according to the calculated display recommendation level P.

The information processing apparatus 100-1 according to the first exemplary embodiment can realize the presentation of appropriate diagnosis dedicated information that reflects the necessity of presenting similar cases to each physician. Further, the information processing apparatus 100-1 according to the first exemplary embodiment calculates the display recommendation level P of each similar case based on an appropriately determined diagnostic difficulty level of the similar case. Therefore, the setting of the display recommendation level P can be performed reliably.

Moreover, the information processing apparatus 100-1 according to the first exemplary embodiment calculates the display recommendation level P of each similar case so as to reflect a skill level of each physician or the degree of physician's experience with respect to the modality to be read. Therefore, the display reflecting the necessity of presenting similar cases to each physician can be realized. The efficiency of the diagnosis can be improved.

Next, a second exemplary embodiment of the present invention is described below.

The above-described information processing apparatus 100-1 according to the first exemplary embodiment calculates the display recommendation level P of each similar case based on the diagnostic difficulty level of each similar case. Compared to the first exemplary embodiment, an information processing apparatus 100-2 according to the second exemplary embodiment calculates the display recommendation level P of each similar case based on not only the diagnostic difficulty level of each similar case but also a disease determination difficulty level obtainable by analyzing a diagnostic target image.

In the present exemplary embodiment, the “disease determination difficulty level” is an index representing the degree of difficulty in disease determination performed by image analysis on the diagnostic target image. Thus, even when the similarity level of a similar case relative to the diagnostic target image is low, i.e., even when the reference level of a similar case is low, the information processing apparatus 100-2 according to the present exemplary embodiment can increase the weighting of the disease determination difficulty level (i.e., another index) to constantly provide a reliable display recommendation level.

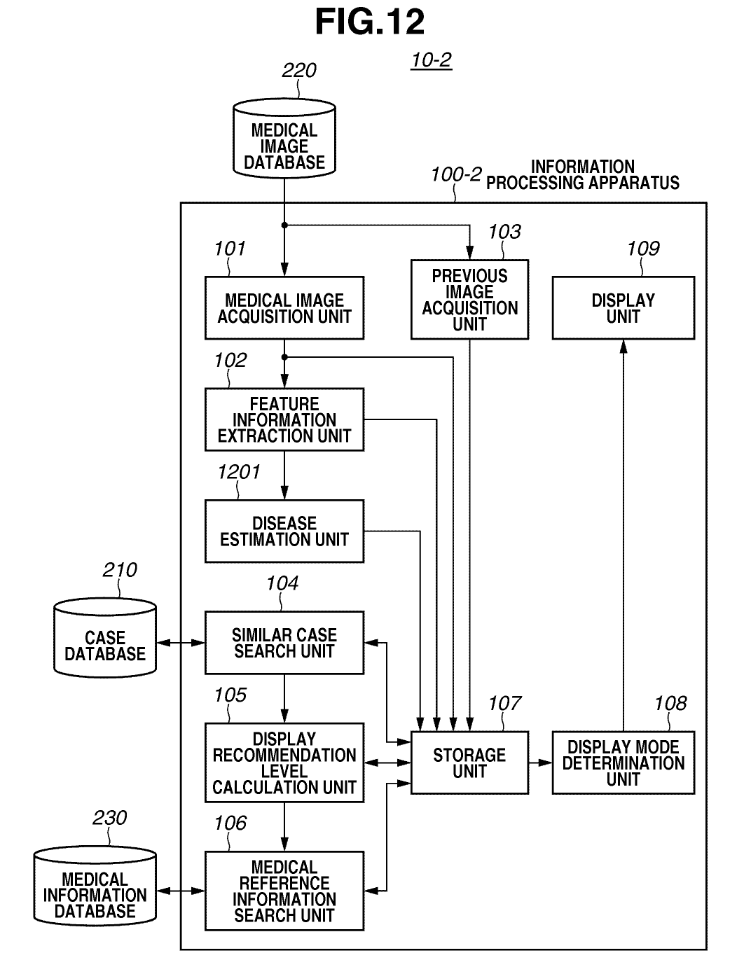

FIG. 12 is a schematic view illustrating an example of a schematic configuration of an information processing system 10-2 according to the second exemplary embodiment of the present invention. In FIG. 12, constituent components similar to those illustrated in FIG. 1 are denoted by the same reference numerals and their detailed descriptions are not repeated.

The information processing system 10-2, as illustrated in FIG. 12, includes the information processing apparatus 100-2, the case database 210, the medical image database 220, and the medical information database 230.

The information processing apparatus 100-2 illustrated in FIG. 12 is different from the information processing apparatus 100-1 illustrated in FIG. 1 in that a disease estimation unit 1201 is additionally provided. The information processing apparatus 100-2 and the information processing apparatus 100-1 are substantially the same in the rest of the configuration.

The disease estimation unit 1201 is functionally configured to estimate a disease based on image feature information extracted by the feature information extraction unit 102.

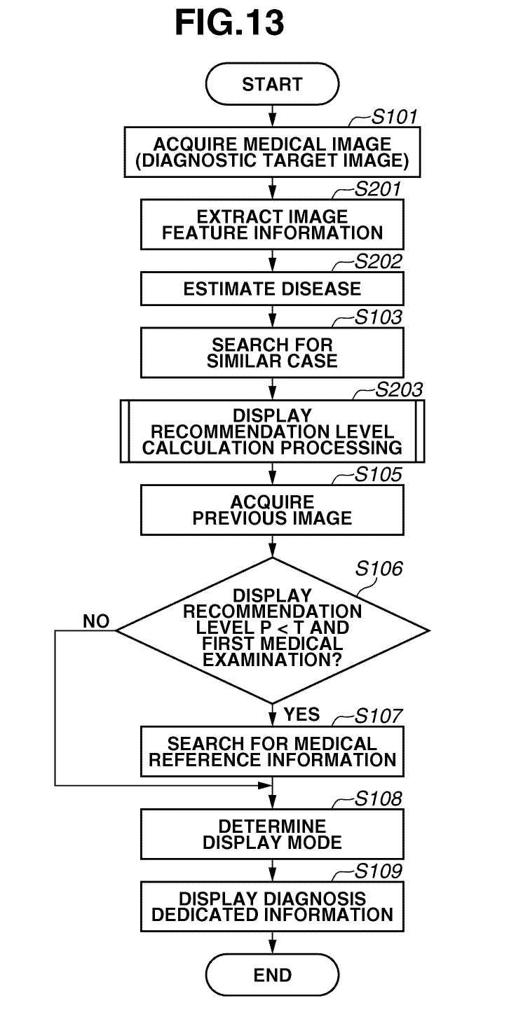

Next, an example operation that can be performed by each functional unit of the information processing apparatus 100-2 according to the second exemplary embodiment is described below with reference to FIG. 13.

FIG. 13 is a flowchart illustrating an example of a processing procedure of an information processing method, which can be performed by the information processing apparatus 100-2 according to the second exemplary embodiment of the present invention. In FIG. 13, processing steps similar to those illustrated in FIG. 2 are denoted by the same step numbers and their descriptions are not repeated.

In the flowchart illustrated in FIG. 13, the information processing apparatus 100-2 executes medical image (diagnostic target image) acquisition processing, which is similar to the processing of step S101 illustrated in FIG. 2.

Subsequently, in step S201, the feature information extraction unit 102 acquires image information of a diagnostic target image from the medical image acquisition unit 101. Then, the feature information extraction unit 102 extracts image feature information from the medical image (diagnostic target image) included in the image information acquired from the medical image acquisition unit 101. A detailed processing content of step S201 is similar to that of step S102 illustrated in FIG. 2 and the description thereof is not repeated.

Then, the feature information extraction unit 102 transmits the image feature information extracted from the diagnostic target image to the storage unit 107 and the disease estimation unit 1201.

Subsequently, in step S202, the disease estimation unit 1201 receives the image feature information of the diagnostic target image from the feature information extraction unit 102. Then, based on the acquired image feature information, the disease estimation unit 1201 performs processing for estimating a disease whose processing result can be obtained as continuous values.

More specifically, for example, the disease estimation unit 1201 can calculate each disease estimation value (a predicted value) as a probability by using the Bayesian network technique described in ‘Burnside E S, Rubin D L, Fine J P, Shachter R D, Sisney G A, Leung W K, “Bayesian network to predict breast cancer risk of mammographic microcalcifications and reduce number of benign biopsy results: initial experience”, Radiology. 2006 September; 240(3):666-73’. For example, when the diagnostic target image is a chest X-ray CT image and the extracted information is image feature information of a pulmonary nodule shade, the disease estimation unit 1201 can calculate disease estimation values in descending order of magnitude with respect to the probability, such as “primary lung cancer”: 0.5, “metastatic lung cancer”: 0.4, and “benign tumor”: 0.1.

Then, the disease estimation unit 1201 transmits information relating to the calculated disease estimation value to the storage unit 107.

Subsequently, the information processing apparatus 100-2 performs similar case search processing, which is similar to the processing in step S103 illustrated in FIG. 2.

Subsequently, in step S203, the display recommendation level calculation unit 105 acquires similar case data from the similar case search unit 104. Further, the display recommendation level calculation unit 105 acquires information relating to the disease estimation value from the storage unit 107.

Next, the display recommendation level calculation unit 105 calculates a “disease determination difficulty level” of the diagnostic target image based on the disease estimation value (predicted value) acquired from the storage unit 107.

Subsequently, the display recommendation level calculation unit 105 calculates a display recommendation level P of a similar case based on a diagnostic difficulty level in the similar case data acquired from the similar case search unit 104 and the calculated disease determination difficulty level of the diagnostic target image.

Then, the display recommendation level calculation unit 105 transmits the calculated display recommendation level P to the medical reference information search unit 106 and the storage unit 107.

Subsequently, the information processing apparatus 100-2 performs processing similar to that of steps S105 to S109 illustrated in FIG. 2 and terminates the processing of the information processing method according to the second exemplary embodiment illustrated in FIG. 13.

Next, similar case display recommendation level calculation processing to be executed in step S203 illustrated in FIG. 13 is described below in more detail.

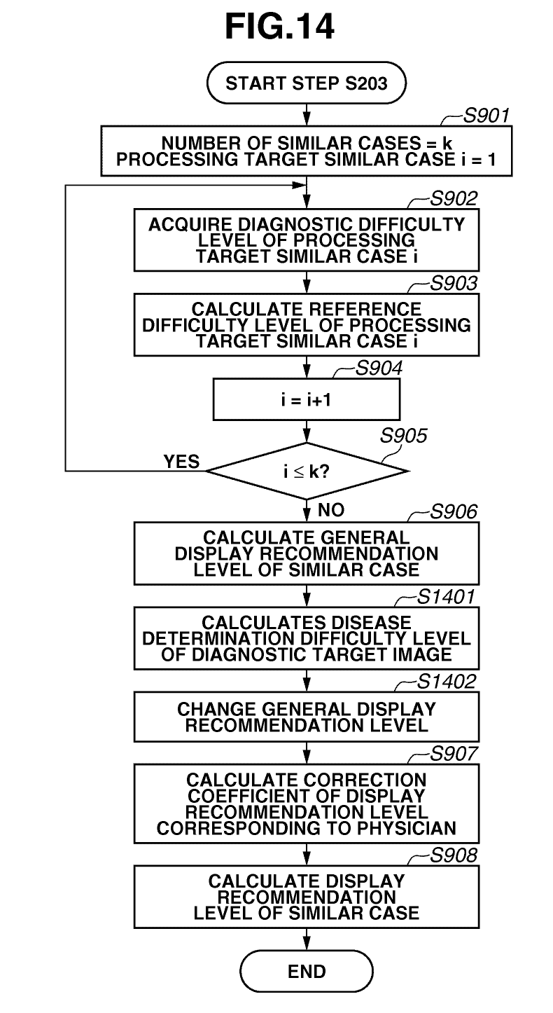

FIG. 14 is a flowchart illustrating an example of a detailed processing procedure of the processing for calculating the similar case display recommendation level to be executed in step S203 illustrated in FIG. 13. In FIG. 14, processing steps similar to those illustrated in FIG. 9 are denoted by the same step numbers and their descriptions are not repeated.

In the flowchart illustrated in FIG. 14, the display recommendation level calculation unit 105 performs processing similar to that of steps S901 to S906 illustrated in FIG. 9.

Subsequently, in step S1401, the display recommendation level calculation unit 105 acquires information relating to the disease estimation value (predicted value) from the storage unit 107. Then, the display recommendation level calculation unit 105 calculates a “disease determination difficulty level” of the diagnostic target image based on the information relating to the disease estimation value acquired from the storage unit 107.

More specifically, in the present exemplary embodiment, the display recommendation level calculation unit 105 calculates a disease determination difficulty level Dₓ of the diagnostic target image according to a difference between two probability values of two diseases that are highest and second highest with respect to the probability of the disease estimation value (predicted value). If there is not any difference between the estimated (predicted) disease probabilities, it can be considered that the determination of the disease is difficult.

In the present exemplary embodiment, p and q (0≦p≦1, 0≦q≦1, p≧q) represent probabilities of two diseases that are highest and second highest with respect to the probability of the disease estimation value. The following formula (12) can be used to calculate the disease determination difficulty level Dₓ of the diagnostic target image.

Dₓ=10·{1−(p−q)} (12)

In the formula (12), if the value Dₓ becomes less than 1 (i.e., Dₓ<1), the value Dₓ is regarded as being equal to 1 (i.e., Dₓ=1). According to the formula (12), if two disease probabilities p and q are 0.5 and 0.4 (i.e., p=0.5 and q=0.4), the disease determination difficulty level Dₓ becomes 9 (i.e., Dₓ=9). Namely, when the difference between two disease probabilities is small, the disease determination difficulty level Dₓ becomes a larger value.

On the other hand, if two disease probabilities p and q are 0.9 and 0.1 (i.e., p=0.9 and q=0.1), the disease determination difficulty level Dₓ becomes 2 (i.e., Dₓ=2). Namely, when the difference between two disease probabilities is large, the disease determination difficulty level Dₓ becomes a smaller value.

Subsequently, in step S1402, the display recommendation level calculation unit 105 performs processing for changing the general display recommendation level Pₛₜ of the similar case calculated in step S906 based on the disease determination difficulty level Dₓ of the diagnostic target image calculated in step S1401.

The processing to be performed in step S1402 is described below in more detail. In the first exemplary embodiment, the similarity level of a similar case is used as a reference level of the similar case relative to the diagnostic target image, when reference difficulty level Rᵢ of the similar case is calculated in step S903.

The second exemplary embodiment is different from the first exemplary embodiment in that the display recommendation level calculation unit 105 calculates a similarity level S_{type} as a reference level representing all similar cases. Further, the similarity level S_{type} can be a similarity level of a similar case having the highest similarity level among the similar cases. In this case, for example, the similarity level S_{type} can be expressed using the following formula (13).

$${S}_{type} = {max}_{1 \leq i \leq k} \{ {S}_{i} \} \qquad ( 13 )$$

Next, the display recommendation level calculation unit 105 obtains a weighted general display recommendation level P′ₛₜ, which is obtainable by weighting a difference between the general display recommendation level Pₛₜ calculated in step 906 and the disease determination difficulty level Dₓ calculated in step S1401 with the value of the similarity level S_{type}. For example, the following formula (14) can be used to perform the above-described weighting calculation.

Pₛₜ′=S_{type}·Pₛₜ+(1−S_{type})·Dₓ (14)

If in the formula (14) the value of the similarity level S_{type} is large, an effect of the general display recommendation level Pₛₜ in the calculation of the weighted general display recommendation level P′ₛₜ becomes larger. On the other hand, if the value of the similarity level S_{type} is small, an effect of the disease determination difficulty level Dₓ in the calculation of the weighted general display recommendation level P′ₛₜ becomes larger.

When the processing of step S1402 is completed, the information processing apparatus according to the present exemplary embodiment performs processing similar to that of steps S907 and S908 illustrated in FIG. 9 and performs the processing for calculating similar case display recommendation level similar to that of step S203 illustrated in FIG. 13.

In the present exemplary embodiment, the weighted general display recommendation level P′ₛₜ calculated in step S1402 is employed as the general display recommendation level Pₛₜ to be used in the processing of step S907.

As described above, even when the similarity level of a similar case relative to the diagnostic target image is low, namely even when the reference level of a similar case is low, the information processing apparatus according to the present exemplary embodiment can constantly provide a reliable display recommendation level by increasing the weighting of the disease determination difficulty level (i.e., another index).

Next, a third exemplary embodiment of the present invention is described below.

The above-described information processing apparatus 100-1 according to the first exemplary embodiment determines a display mode of each similar case based on a diagnostic difficulty level of medical case data relating to the similar case. Compared to the first exemplary embodiment, an information processing apparatus according to the third exemplary embodiment determines a display mode of each similar case based on a “treatment determination difficulty level” that represents the difficulty in determination of a treatment.

In this case, the treatment determination difficulty can be classified into a treatment method determination difficulty and a treatment timing determination difficulty. If determining a treatment method is difficult, it is useful to refer to the treatment method of a similar case. Further, if determining timing of the treatment is difficult, it is useful to refer to treatment timing of a similar case.

Accordingly, in the third exemplary embodiment, the “treatment determination difficulty level” is expressed using two parameters representing the treatment method determination difficulty and the treatment timing determination difficulty. The display mode of each similar case is determined according to these parameters.

As described above, determining the display mode of each similar case based on the treatment determination difficulty level can realize an appropriate presentation of medical information that reflects the necessity of presenting similar cases to a physician considering the difficulty in determining a treatment, for example, when a physician in charge decides the content of a treatment or in a conference held to discuss detailed contents of a treatment to be practiced.

A schematic configuration of an information processing system including an information processing apparatus according to the third exemplary embodiment is similar to the information processing system 10-1 including the information processing apparatus 100-1 according to the first exemplary embodiment illustrated in FIG. 1, although not illustrated in the drawings.

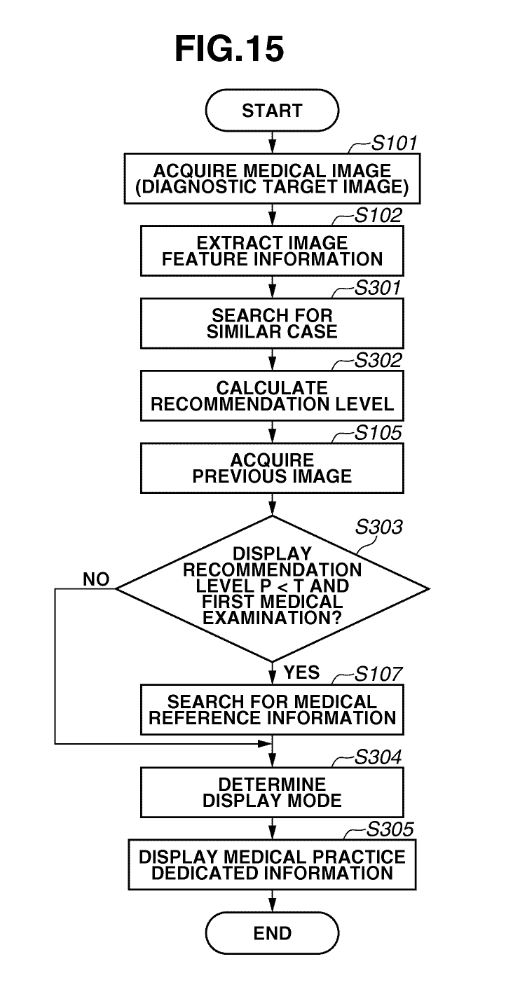

Next, an example operation that can be performed by each functional unit of the information processing apparatus 100-1 according to third exemplary embodiment is described below with reference to a flowchart illustrated in FIG. 15.

FIG. 15 is a flowchart illustrating an example of a processing procedure of an information processing method, which can be performed by the information processing apparatus 100-1 according to the third exemplary embodiment of the present invention. In FIG. 15, processing steps similar to those illustrated in FIG. 2 are denoted by the same step numbers and their descriptions are not repeated.

In the flowchart illustrated in FIG. 15, the information processing apparatus 100-1 performs processing similar to that of steps S101 and S102 illustrated in FIG. 2. In this case, in step S101, the medical image acquisition unit 101 acquires, from the medical image database 220, image information relating to a medical image of a subject that is designated as a medical practice target by a physician.

In the present exemplary embodiment, the medical image of a subject designated as a medical practice target is referred to as a “medical practice target image.” Then, in step 102, the feature information extraction unit 102 extracts image feature information from the medical practice target image and transmits the extracted image feature information of the medical practice target image to the storage unit 107.

Subsequently, in step S301, the similar case search unit 104 acquires the image feature information of the medical practice target image, which was stored in the storage unit 107 in step S102. Next, the similar case search unit 104 performs similar case search processing to extract, from the case database 210, medical case data having image feature information similar to the acquired image feature information of the medical practice target image.

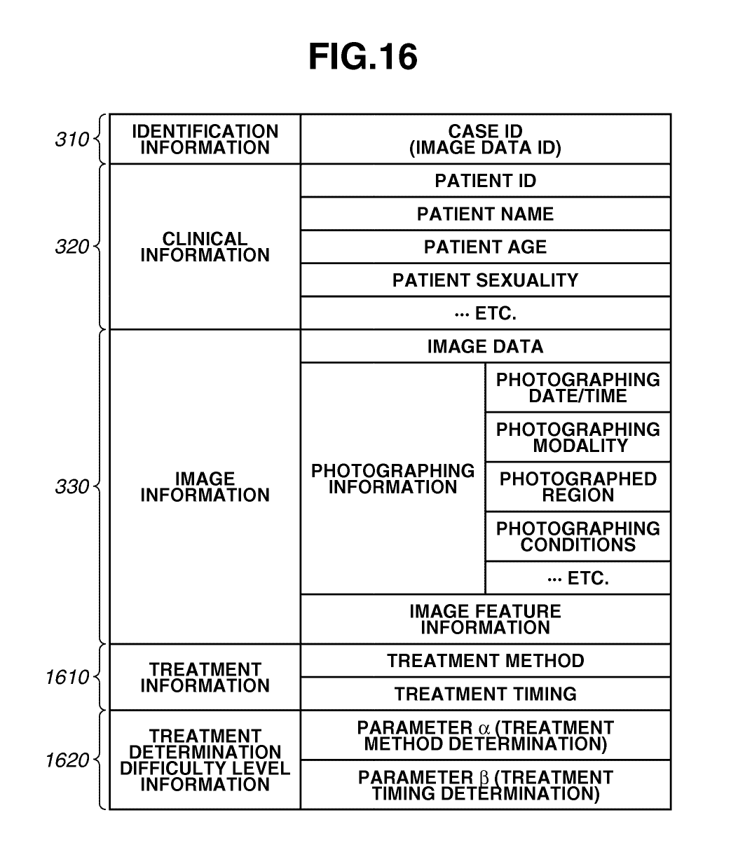

FIG. 16 is a schematic view illustrating an example content of the medical case data stored in the case database 210 illustrated in FIG. 1 according to the third exemplary embodiment of the present invention. In FIG. 16, constituent components similar to those illustrated in FIG. 3 are denoted by the same reference numerals and their detailed descriptions are not repeated.

As illustrated in FIG. 16, the medical case data stored in the case database 210 according to the present exemplary embodiment includes treatment information 1610 and treatment determination difficulty level information 1620 in addition to the identification information 310, the clinical information 320, and the image information 330.

More specifically, the medical case data illustrated in FIG. 16 according to the third exemplary embodiment is different from the medical case data illustrated in FIG. 3 according to the first exemplary embodiment in that the diagnostic information 340 is replaced by the treatment information 1610 and the diagnostic difficulty level information 350 is replaced by the treatment determination difficulty level information 1620.

In other words, according to the medical case data according to the present exemplary embodiment, examination information of a subject (e.g., the identification information 310, the clinical information 320, the image information 330, and the treatment information 1610) is associated with the treatment determination difficulty level information 1620 that represents the difficulty level of a medical practice.

More specifically, the treatment information 1610 includes information relating to a treatment method and information relating to timing of the treatment. Further, the treatment determination difficulty level information 1620 includes a parameter α and a parameter β. The parameter α is a value selected from 1 to 10 and represents a treatment method determination difficulty level. The parameter β is a value selected from 1 to 10 and represents a treatment timing determination difficulty level.

According to the example illustrated in FIG. 16, both of the parameter α representing the treatment method determination difficulty level and the parameter β representing the treatment timing determination difficulty level are necessary as the treatment determination difficulty level information 1620. However, only one of two parameters α and β can be used as the treatment determination difficulty level information 1620.

The similar case search processing to be performed in step 301 is similar to the processing of step S103 illustrated in FIG. 2 described in the first exemplary embodiment, although its detailed description is not repeated.

Then, the similar case search unit 104 transmits k pieces of similar case data acquired through the similar case search processing to the display recommendation level calculation unit 105 and the storage unit 107.

Subsequently, in step S302, the display recommendation level calculation unit 105 receives the similar case data from the similar case search unit 104. Then, the display recommendation level calculation unit 105 calculates a display recommendation level P of the similar case based on a treatment determination difficulty level of the acquired similar case data.

More specifically, when D={α, β} represents the treatment determination difficulty level of the similar case, P={αₚ, βₚ} represents the display recommendation level of the similar case calculated based on the treatment determination difficulty level D={α, β} in the processing of step 302.

In other words, the display recommendation level P can be defined with the parameter αₚ representing a treatment method display recommendation level of the similar case and the parameter βₚ representing a treatment timing display recommendation level of the similar case.

For example, an example of the processing can be realized using a flowchart similar to that illustrated in FIG. 9 describing the processing for calculating similar case display recommendation level according to the first exemplary embodiment, although it is necessary to replace the diagnostic difficulty level and the display recommendation level by the parameters αₚ and βₚ.

Then, the display recommendation level calculation unit 105 transmits the calculated display recommendation level P={αₚ, βₚ} to the medical reference information search unit 106 and the storage unit 107.

Subsequently, the information processing apparatus 100-1 performs previous image acquisition processing similar to the processing of step S105 illustrated in FIG. 2.

Further, in step S303, the medical reference information search unit 106 acquires the display recommendation level P={αₚ, βₚ} from the display recommendation level calculation unit 105 and the value of the first medical examination flag F from the storage unit 107. Then, the medical reference information search unit 106 determines whether the acquired values of the parameters αₚ and βₚ of the display recommendation level Pare less than the first threshold T (i.e., αₚ<T and βₚ<T) and whether the first medical examination flag F is “True” (i.e., the first medical examination).

Then, if it is determined that the acquired values of the parameters αₚ and βₚ of the display recommendation level P are less than the first threshold T and the first medical examination flag F is “True” (YES in step S303), the processing proceeds to step S107. On the other hand, if it is determined that at least one of the acquired values of the parameters αₚ and βₚ of the display recommendation level P is not less than the first threshold T or the first medical examination flag F is not “True” (NO in step S303), the processing proceeds to step S304.

In the present exemplary embodiment, similar to the first exemplary embodiment, a setting value of the first threshold T is equal to 0.5 (i.e., T=0.5). The determination processing of step S303 indicates that the medical reference information search processing (i.e., processing in step S107) is performed only when the values of the parameters αₚ and βₚ of the display recommendation level P of the medical practice target image is less than the first threshold T and the preset medical practice is the first medical examination.

As described above, if it is determined that at least one of the acquired values of the parameters αₚ and βₚ of the display recommendation level P is not less than the first threshold T or the first medical examination flag F is not “True” (NO in step S303), the processing proceeds to step S304. Further, when the processing of step S107 is completed, the processing proceeds to step S304.

When the processing proceeds to step S304, the display mode determination unit 108 acquires, from the storage unit 107, image information of the medical practice target image, image information of previous image(s), similar case data, medical reference information, the value of the first medical examination flag F, and the value of the display recommendation level P={αₚ, βₚ}.

Next, the display mode determination unit 108 determines a display mode M (M is any one of M₇ to M₁₁) for displaying the contents of the acquired image information of the medical practice target image, the image information of previous image(s), the similar case data, and the medical reference information based on the acquired values of the first medical examination flag F and the display recommendation level P.

Then, the display mode determination unit 108 transmits, to the display unit 109, information relating to the determined display mode M in addition to the information acquired from the storage unit 107 including the image information of the medical practice target image, the image information of previous image(s), the similar case data, and the medical reference information.

Subsequently, in step S305, the display unit 109 receives the value relating to the display mode M (i.e., any one of M₇ to M₁₁) as well as the image information of the medical practice target image, the image information of previous image(s), the similar case data, and the medical reference information, which are transmitted from the display mode determination unit 108.

Then, the display unit 109 displays medical practice dedicated information including the acquired image information of the medical practice target image, the image information of previous image(s), the similar case data, and the medical reference information, on a medical practice dedicated screen of the monitor (not illustrated) according to the acquired display mode M.

Therefore, each physician can perform a medical practice (e.g., treatment) for a patient (i.e., subject) while viewing the medical practice dedicated information displayed on the medical practice dedicated screen of the monitor (not illustrated).

When the processing of step S305 is completed, the information processing apparatus according to the present exemplary embodiment terminates the processing of the information processing method according to the third exemplary embodiment illustrated in FIG. 15.

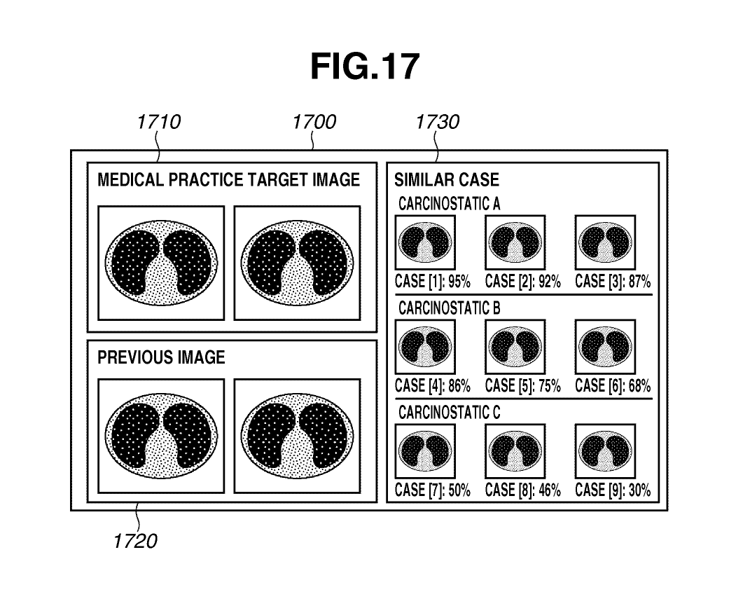

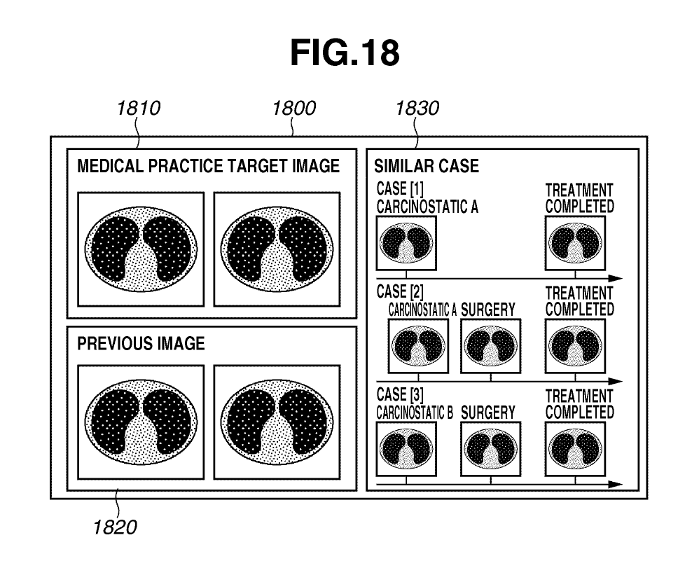

Next, the display mode M determined in step S304 is described below with reference to FIG. 17 and FIG. 18.

First, in a case where the parameters α_{P} and β_{P} of the display recommendation level P are less than the first threshold T (i.e., α_{P}<T and β_{P}<T), displaying both the treatment method and the treatment timing of similar cases may be unnecessary. Therefore, a display mode M₇ that does not present any similar cases is employable. The display mode M₇ is similar to the display mode M₁ described in the first exemplary embodiment in a way of presenting none of similar cases, although its detailed description is not repeated.

FIG. 17 is a schematic view illustrating an example of a display mode M₈ according to the third exemplary embodiment of the present invention, which is employable when the first medical examination flag F is “False” (i.e., other than the first medical examination) and the parameter α_{P} of the display recommendation level P satisfies a relationship α_{P}≧T and α_{P}>β_{P}.

More specifically, the example illustrated in FIG. 17 is an example of the display mode M₈, which is employable when the display recommendation level (α_{P}) relating to the treatment method is equal to or greater than the first threshold T and is greater than the display recommendation level (β_{P}) relating to the treatment timing.

A medical practice dedicated screen 1700 illustrated in FIG. 17 includes a medical practice target image display area 1710 positioned on the upper left side, a previous image display area 1720 on the lower left side, and a similar case display area 1730 on the right side.

As illustrated in FIG. 17, a list of a plurality of medical cases is displayed in the similar case display area 1730, in which the displayed cases [1] to [9] are arranged in descending order of magnitude with respect to the similarity level in each type of the treatment method.

As described above, when the display recommendation level P of a treatment method is high, displaying similar cases for each type of the treatment method enables each physician to compare a medical practice target image with an assembly of similar cases belonging to the same treatment method and determine a treatment method suitable for the medical practice target referring to the presented useful information.

FIG. 18 is a schematic view illustrating an example of a display mode M₉ according to the third exemplary embodiment of the present invention, which is employable when the first medical examination flag F is “False” (i.e., other than the first medical examination) and the parameter β_{P} of the display recommendation level P satisfies a relationship β_{P}≧T and β_{P}≧α_{P}.

More specifically, the example illustrated in FIG. 18 is an example of the display mode M₉, which is employable when the display recommendation level (β_{P}) relating to the treatment timing is equal to or greater than the first threshold T and is equal to or greater than the display recommendation level relating to the treatment method (β_{P}≧α_{P}).

A medical practice dedicated screen 1800 illustrated in FIG. 18 includes a medical practice target image display area 1810 positioned on the upper left side, a previous image display area 1820 on the lower left side, and a similar case display area 1830 on the right side. As illustrated in FIG. 18, a list of a plurality of medical cases is displayed in the similar case display area 1830, in which time sequence information relating to treatment processes relating to a patient is displayed for each similar case (medical case [1] to medical case [3]).

As described above, when the display recommendation level P of treatment timing is high, displaying time sequence information of treatment processes in each similar case can present useful information to each physician when the physician determines treatment timing for the medical practice target.

Further, display modes to be selected when the first medical examination flag F is “True” (i.e., the first medical examination) are different from the above-described display modes M₈ and M₉ in that only the medical practice target image is displayed in the left display area without displaying any previous images, although not described in detail. These display modes are referred to as display modes M₁₀ and M₁₁, respectively.

As described above, the information processing apparatus 100-1 according to the third exemplary embodiment calculates a display recommendation level P of each similar case based on a treatment determination difficulty level of medical case data relating to the similar case and determines a display mode suitable for the similar case in the treatment according to the calculated display recommendation level P.

The information processing apparatus 100-1 according to the third exemplary embodiment can realize the presentation of appropriate medical practice dedicated information that reflects the necessity of presenting similar cases to each physician when the physician determines the content of each treatment. Further, information processing apparatus 100-1 according to the third exemplary embodiment calculates the display recommendation level P of each similar case based on an appropriately determined treatment difficulty level of the similar case. Therefore, the setting of the display recommendation level P can be performed reliably.

Next, a fourth exemplary embodiment of the present invention is described below. The present invention can be embodied, for example, as an information processing system, an information processing apparatus, an information processing method, a program, or a storage medium. More specifically, the present invention can be applied to an information processing system including a plurality of devices, or can be applied to an information processing apparatus including only one device.

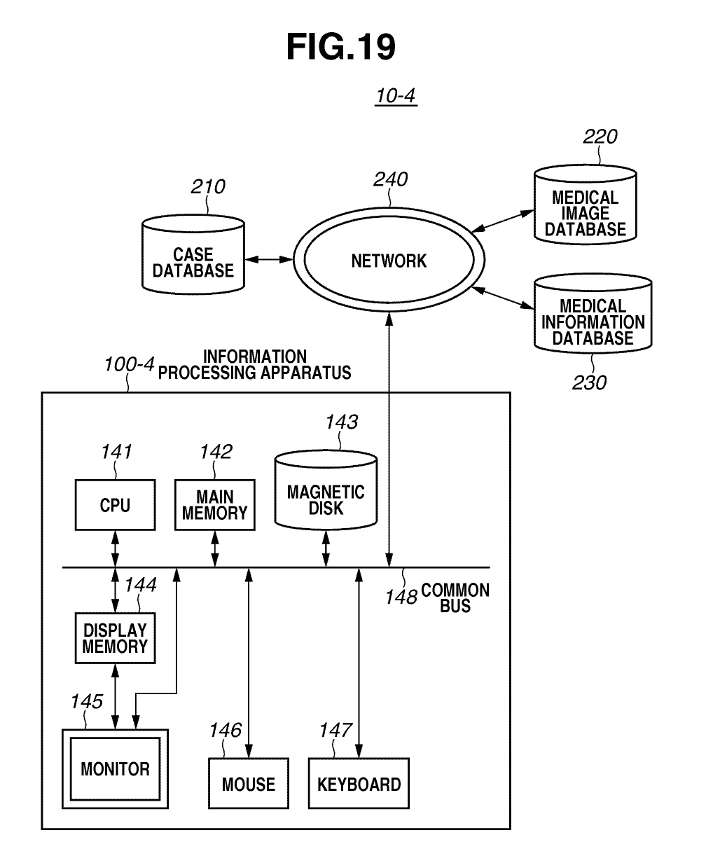

FIG. 19 is a schematic view illustrating an example of a hardware configuration of an information processing system 10-4 according to the fourth exemplary embodiment of the present invention. In FIG. 19, constituent components similar to those illustrated in FIG. 1 are denoted by the same reference numerals and their descriptions are not repeated.

The information processing system 10-4, as illustrated in FIG. 19, includes an information processing apparatus 100-4, the case database 210, the medical image database 220, the medical information database 230, and a network 240.

The information processing apparatus 100-4 includes a central processing unit (CPU) 141, a main memory 142, a magnetic disk 143, a display memory 144, a monitor 145, a mouse 146, a keyboard 147, and a common bus 148.

The CPU 141 mainly controls operations that can be performed by respective constituent elements of the information processing apparatus 100-4. Namely, the CPU 141 is functionally operable to integrally control various operations to be performed by the information processing apparatus 100-4.

For example, the CPU 141 executes a program stored in the main memory 142 to communicate with the case database 210, the medical image database 220, and the medical information database 230 via the network 240. Further, for example, the CPU 141 executes a program stored in the main memory 142 to perform various controls including an overall control of the information processing apparatus 100-4.

The main memory 142 stores programs that can be executed by the CPU 141 and provides a work area when the CPU 141 executes each program.

The magnetic disk 143 stores an operating system (OS), device drivers of peripheral devices, various types of application software, and work data that are generated or used by the application software.

The display memory 144 temporarily stores display data to be displayed on the monitor 145.

The monitor 145 is, for example, a cathode ray tube (CRT) monitor or a liquid crystal monitor, which can display various images and various types of information based on the display data stored in the display memory 144 under the control of the CPU 141. Further, if necessary, an operational status and an operational result of the program executed by the CPU 141 can be displayed on the monitor 145.

The mouse 146 and the keyboard 147 enable users to perform pointing input and character input operations. Users (physicians) can input various commands (instructions and commands) to the information processing apparatus 100-4 by manipulating the mouse 146 and the keyboard 147.

The common bus 148 connects the constituent elements of the information processing apparatus 100-4 to enable respective constituent elements to communicate with each other. Further, the common bus 148 connects the information processing apparatus 100-4 and the network 240 to enable the information processing apparatus 100-4 to communicate with external devices.

More specifically, the network 240 connects the information processing apparatus 100-4 to each of the case database 210, the medical image database 220, and the medical information database 230 so that the information processing apparatus 100-4 can communicate with the case database 210, the medical image database 220, and the medical information database 230.

The network 240 is, for example, a local area network (LAN) based on Ethernet® or Internet. The network 240 can be replaced by any other interface (such as Universal Serial Bus (USB) or IEEE1394).

The schematic configuration (functional configuration) of the information processing apparatus 100-1 illustrated in FIG. 1 and the schematic configuration (functional configuration) of the information processing apparatus 100-2 illustrated in FIG. 12 are characteristic as follows in relationship with the hardware configuration of the information processing apparatus 100-4 illustrated in FIG. 19.

For example, the CPU 141, the program(s) stored in the main memory 142, the mouse 146, and the keyboard 147 illustrated in FIG. 19 cooperatively constitute the medical image acquisition unit 101, the previous image acquisition unit 103, the similar case search unit 104, and the medical reference information search unit 106 illustrated in FIG. 1 and FIG. 12.

Further, for example, the CPU 141 and the program(s) stored in the main memory 142 illustrated in FIG. 19 cooperatively constitute the feature information extraction unit 102, the display recommendation level calculation unit 105, and the display mode determination unit 108 illustrated in FIG. 1 and FIG. 12, and the disease estimation unit 1201 illustrated in FIG. 12.

Further, for example, the main memory 142 or the magnetic disk 143 illustrated in FIG. 19 can constitute the storage unit 107. Further, for example, the CPU 141, the program(s) stored in the main memory 142, the display memory 144, the monitor 145, the mouse 146, and the keyboard 147 illustrated in FIG. 19 cooperatively constitute the display unit 109 illustrated in FIG. 1 and FIG. 12.

### Other Embodiments

Further, the present invention can be realized by executing the following processing. More specifically, the processing includes supplying a software program that can realize the functions of the above-described exemplary embodiments to a system or an apparatus via a network or an appropriate storage medium and causing a computer (or a CPU or a microprocessor unit (MPU)) incorporated in the system or the apparatus to read and execute the program. In this respect, the present invention encompasses the program itself and a computer-readable storage medium storing the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-246929 filed Oct. 27, 2009, which is hereby incorporated by reference herein in its entirety.

What is claimed is:

1. An information processing apparatus comprising:
a similar case search unit configured to search for similar case data, which is medical case data including examination information similar to examination information of a medical practice target in characteristics, from a medical case data storage unit that stores medical case data including examination information of a subject associated with medical practice difficulty level information based on the examination information;
a display mode determination unit configured to determine a display mode applicable to the similar case data based on a medical practice difficulty level of the similar case data; and
a display unit configured to display the similar case data according to the display mode determined by the display mode determination unit.

2. The information processing apparatus according to claim 1, wherein the medical practice difficulty level includes at least one of a diagnostic difficulty level and a treatment determination difficulty level based on the examination information of the subject.

3. The information processing apparatus according to claim 2, wherein the treatment determination difficulty level is either one or both of a treatment method determination difficulty level and a treatment timing determination difficulty level.

4. The information processing apparatus according to claim 1, further comprising a display recommendation level calculation unit configured to calculate a display recommendation level of the similar case data based on the medical practice difficulty level of the similar case data searched by the similar case search unit,
wherein the display mode determination unit is configured to use the display recommendation level to determine the display mode applicable to the similar case data.

5. The information processing apparatus according to claim 4, wherein the display recommendation level calculation unit is configured to calculate the display recommendation level of the similar case data using a weighted value obtained by weighting the medical practice difficulty level of the similar case data based on a similarity level of the similar case data.

6. The information processing apparatus according to claim 4, wherein the display recommendation level calculation unit is configured to calculate the display recommendation level of the similar case data using a corrected value obtainable by correcting the medical practice difficulty level of the similar case data based on at least one of skill level and specialty of a physician who performs medical practice.

7. The information processing apparatus according to claim 4, wherein the display mode determination unit is configured to determine a display mode that does not display any similar case data if the display recommendation level is less than a first threshold and determine a display mode that displays the similar case data if the display recommendation level is equal to or greater than the first threshold.

8. The information processing apparatus according to claim 7, wherein the medical practice difficulty level is a diagnostic difficulty level based on the examination information of the subject, and the display mode determination unit is configured to determine a display mode that displays the similar case data for each classified disease if the display recommendation level is equal to or greater than a second threshold, wherein the second threshold is greater than the first threshold.

9. The information processing apparatus according to claim 7, wherein the medical practice difficulty level is a treatment determination difficulty level based on the examination information of the subject, and
the display recommendation level calculated by the display recommendation level calculation unit includes a treatment method display recommendation level and a treatment timing display recommendation level,
wherein the display mode determination unit is configured to determine a display mode that displays the similar case data for each type of the treatment method if the treatment method display recommendation level is equal to or greater than the first threshold and is greater than the treatment timing display recommendation level.

10. The information processing apparatus according to claim 7, wherein the medical practice difficulty level is a treatment determination difficulty level based on the examination information of the subject, and
the display recommendation level calculated by the display recommendation level calculation unit includes a treatment method display recommendation level and a treatment timing display recommendation level,
wherein the display mode determination unit is configured to determine a display mode that displays time sequence information of treatment processes in the similar case data if the treatment timing display recommendation level is equal to or greater than the first threshold and is equal to or greater than the treatment method display recommendation level.

11. The information processing apparatus according to claim 4, wherein the display recommendation level calculation unit is further configured to calculate a disease determination difficulty level based on analysis on the examination information of the medical practice target and calculate a display recommendation level of the similar case data, using the medical practice difficulty level and the disease determination difficulty level of the similar case data searched by the similar case search unit.

12. An information processing method comprising:
searching for similar case data, which is medical case data including examination information similar to examination information of a medical practice target in characteristics, from a medical case data storage unit that stores medical case data including examination information of a subject associated with medical practice difficulty level information based on the examination information;
determining a display mode applicable to the similar case data based on a medical practice difficulty level of the similar case data; and
displaying the similar case data according to the determined display mode.

13. A computer-readable storage medium storing a program that causes a computer to execute information processing, comprising:
computer-executable instructions for searching for similar case data, which is medical case data including examination information similar to examination information of a medical practice target in characteristics, from a medical case data storage unit that stores medical case data including examination information of a subject associated with medical practice difficulty level information based on the examination information;
computer-executable instructions for determining a display mode applicable to the similar case data based on a medical practice difficulty level of the similar case data; and
computer-executable instructions for displaying the similar case data according to the determined display mode.
